(19) United States
(12) Patent Application Publication
(10) Pub. No.: US 2014/0259012 A1
(43) Pub. Date: Sep. 11, 2014

(54) VIRTUAL MACHINE MOBILITY WITH EVOLVED PACKET CORE

(71) Applicant: TELEFONAKTIEBOLAGET L M ERICSSON (PUBL), Stockholm (SE)

(72) Inventors: Vishwamitra Nandlall, McKinney, TX (US); Haseeb Akhtar, Garland, TX (US); Francois Lemarchand, Palasieseau (FR)

(73) Assignee: TELEFONAKTIEBOLAGET L M ERICSSON (PUBL), Stockholm (SE)

(21) Appl. No.: 14/155,986

(22) Filed: Jan. 15, 2014

Related U.S. Application Data
(60) Provisional application No. 61/773,415, filed on Mar. 6, 2013.

(51) Int. Cl. G06F 9/455; H04W 8/02

(52) U.S. Cl. CPC G06F 9/45533; H04W 8/02
USPC 718/1

(57) ABSTRACT

A system and method for controlling mobility of a subscriber-specific Virtual Machine (VM) instance from one VM to another VM using a network node (such as an Evolved Packet Gateway (EPG)) in an Evolved Packet Core (EPC) in a mobile communication network. The EPG may control the VM mobility for each subscriber in the context of cloud-based services or virtualized applications. The EPG may use GPRS Tunneling Protocol (GTP) tunnels rooted at the EPG to Data Center (DC) VMs to govern intra-DC and inter-DC mobility of VMs and also to tie in the mobility triggers to service provider's policies. Each VM session for the mobile subscribers is anchored in the EPG, which then assumes the control of VM mobility for each subscriber through the new GTP interface with the VMs. The EPC-based control of VM mobility can provide optimization of cloud services accessed by a subscriber over a mobile connection.

### CROSS-REFERENCE TO RELATED APPLICATIONS

This application claims the priority benefit under 35 U.S.C. §119(e) of U.S. Provisional Application No. 61/773,415 filed on Mar. 6, 2013, the disclosure of which is incorporated herein by reference in its entirety.

### TECHNICAL FIELD

The present disclosure generally relates to deployment of virtualized applications and cloud-based services for subscribers in a mobile communication network. More particularly, and not by way of limitation, particular embodiments of the present disclosure are directed to a system and method for controlling mobility of a subscriber-specific Virtual Machine (VM) instance (associated with a subscriber-specific VM session) from one VM to another VM using a network node in a packet-switched Core Network (CN) (such as an Evolved Packet Core (EPC)) in the mobile communication network.

### BACKGROUND

Virtualized applications or cloud-based services are increasingly offered by cellular service providers to their subscribers or supported by service providers in their cellular networks. These virtualized applications or cloud-based services may relate to telecommunications (e.g., wireless audio and/or video content delivery), Information Technology (IT) (e.g., remote diagnostics and troubleshooting), Internet or World Wide Web (e.g., online shopping, online gaming, streaming of audio-visual content, web surfing), etc. As is known, a virtualized application is a software application that is encapsulated (i.e., isolated or “sandboxed”) from the underlying operating system so as to allow it to run with different user operating systems. Virtualized applications may be imported to client computers without the need of installing them. Cloud-based services provide similar flexibility and portability across multiple users and multiple device platforms. For ease of discussion, the terms “virtualized application” and “cloud-based service” may be used interchangeably below.

FIG. 1 illustrates an exemplary network configuration 20 showing how virtualized applications and cloud-based services are currently deployed for subscribers in a mobile communication network 22. The mobile communication network 22 may be a cellular telephone network operated, managed, owned, or leased by a wireless/cellular service provider or operator. In the discussion herein, the terms “wireless network,” “mobile communication network,” “operator network,” or “carrier network” may be used interchangeably to refer to a wireless communication network, for example a cellular network, a proprietary data communication network, a corporate-wide wireless network, and the like, facilitating voice and/or data communication with wireless devices such as the devices 24-28. The wireless network 22 may be a dense network with a large number of wireless terminals such as User Equipments or UEs operating therein. It is understood that there may be stationary devices such as Machine-to-Machine (M2M) devices as well as mobile devices such as mobile handsets/terminals or UEs operating in the network 22.

In the embodiment of FIG. 1, the mobile communication network 22 is shown to include an Access Network (AN) portion 30 coupled to a Core Network (CN) portion 32. The AN 30 may include multiple cell sites (not shown), each under the radio coverage of a respective Base Station (BS) or Base Transceiver Station (BTS) 34-36. In FIG. 1, user devices 24-26 may be under the radio coverage of the BS 34, the user device 27 may be under the radio coverage of the BS 35, and the user device 28 may be under the radio coverage of and in communication with the BS 36. In case of cellular access, the term “Access Network” may include not only a Radio Access Network (RAN) portion including for example, a base station with or without a base station controller of a cellular carrier network (e.g., the network 22), but other portions as well, such as a cellular backhaul with or without a portion of the CN 32. Different Radio Access Technology (RAT)—such as Wireless Fidelity (WiFi) RAT—may be supported by its corresponding RAN. Generally speaking, the term “RAN” may refer to a portion, including hardware and software modules, of the service provider's AN that facilitates voice calls, data transfers, and multimedia applications such as Internet access, online gaming, content downloads, video chat, etc. for the wireless devices 24-28.

In FIG. 1, the BS 34 (e.g., a WiFi Access Point (AP)) is shown to be coupled to a backhaul portion that includes a Broadband Network Gateway (BNG) 38 that routes Internet Protocol (IP) traffic from/to broadband-enabled remote access devices (e.g., the devices 24-26) to/from the Internet (not shown) through the cellular operator's backbone network (including the CN 32). A BNG may serve as an access gteway point for subscribers, through which they connect to a broadband network or Internet or a cloud-based service platform. When a connection is established between a BNG and Customer Premises Equipment (CPE) (e.g., the devices 24-26), the subscriber(s) can access various broadband services provided by the network operator or a third party such as an Internet Service Provider (ISP). The BNG 38 may aggregate traffic from various subscriber sessions from an access network, for example a fixed-IP broadband access network (not shown in FIG. 1), a Wireless Local Area Network (WLAN), or a Wi-Fi network, and route that traffic to the CN 32 of the service provider for further processing. The access network may not be a Third Generation Partnership Project (3GPP) network. Using a BNG 38, different subscribers can be provided different cellular network services. This enables the service provider to customize the broadband package for each customer based on their needs.

On the other hand, each of the other two base stations 35-36 in FIG. 1 are shown to be coupled to a respective Third Generation (3G) RAN or Fourth Generation (4G) RAN (collectively referred to using the reference numeral “40” in FIG. 1) that provides radio interface to corresponding wireless devices 27-28 and enables these devices to communicate with various entities in the operator's network 22 (and beyond) using device-selected RAT. As shown in FIG. 1, a common CN functionality (i.e., CN 32) may be shared by the 3G and 4G RANs 40. Alternatively, each 3G or 4G RAN may have its own associated CN, and some form of interworking may be employed in the operator's network 22 to link the two RAN-specific core networks.

The base stations 34-36 may be, for example, evolved NodeBs (eNodeBs or eNBs), high power and macro-cell base stations or relay nodes, WiFi APs (Access Points), etc. These base stations may receive wireless communication from the respective wireless terminals 24-28 and other such terminals operating in the network 22, and forward the received communication to the CN 32 through the corresponding cellular backhaul or RAN portion. The wireless terminals 24-28 may use suitable RATs (examples of which are provided below) to communicate with the corresponding base stations in the RANs. In case of a Third Generation (3G) RAN, for example, the cellular backhaul (not shown) may include functionalities of a 3G Radio Network Controller (RNC) or Base Station Controller (BSC). Portions of the backhaul such as, for example, BSCs or RNCs, together with base stations may be considered to comprise the RAN portion of the network.

Some exemplary RANs 40 include RANs in Third Generation Partnership Project's (3GPP) Global System for Mobile communications (GSM), Universal Mobile Telecommunications System (UMTS), Long Term Evolution (LTE), and LTE Advanced (LTE-A) networks. These RANS include, for example, GERAN (GSM/EDGE RAN, where “EDGE” refers to Enhanced Data Rate for GSM Evolution systems), Universal Terrestrial Radio Access Network (UTRAN), and Evolved-UTRAN (E-UTRAN). The corresponding RATs for these 3GPP networks are: GSM/EDGE for GERAN, UTRA for UTRAN, E-UTRA for E-UTRAN, and Wideband Code Division Multiple Access (WCDMA) based High Speed Packet Access (HSPA) for UTRAN or E-UTRAN. Similarly, Evolution-Data Optimized (EV-DO) based evolved Access Network (eAN) is an exemplary RAN in 3GPP2's Code Division Multiple Access (CDMA) based systems, and its corresponding RATs are 3GPP2's CDMA based High Rate Packet Data (HRPD) or evolved HRPD (eHRPD) technologies. As another example, HRPD technology or Wireless Local Area Network (WLAN) technology may be used as RATs for a Worldwide Interoperability for Microwave Access (WiMAX) RAN based on Institute of Electrical and Electronics Engineers (IEEE) standards such as, for example, IEEE 802.16e and 802.16m.

When the operator's network 22 is a 3GPP network such as an LTE network, each of the wireless devices 24-28 may be a User Equipment (UE) or a Mobile Station (MS). In case of the operator's network 22 being an HRPD network, each of the wireless devices 24-28 may be an Access Terminal (AT) (or evolved AT). The wireless devices may also be referred to by various analogous terms such as a “mobile handset,” a “wireless handset,” a “terminal,” and the like. Generally, each of the wireless devices may be any multi-mode mobile handset enabled, for example, by the device manufacturer or the network operator, for communications over corresponding RATs supported by associated RANs. Some examples of such mobile handsets/devices include cellular telephones or data transfer equipments (e.g., a Personal Digital Assistant (PDA) or a pager), smartphones (e.g., iPhone™, Android™ phones, Blackberry™, etc.), handheld or laptop computers, Bluetooth® devices, electronic readers, portable electronic tablets, interactive gaming units, etc. For the sake of simplicity, in the discussion herein, the term “UE” may be primarily used as representative of all such wireless devices, that is AT's, MS's, or other mobile terminals, regardless of the type of the RANs/RATs (i.e., whether a 3GPP system, a 3GPP2 system, WiFi system, etc.).

The Core Network (CN) 32 may provide logical, service, and control functions such as subscriber account management, billing, subscriber mobility management, and the like, as well as Internet Protocol (IP) connectivity and interconnection to other networks such as the Internet or an Internet-based service network such as a Data Center (DC) 42 or entities, roaming support, etc. In the embodiment of FIG. 1, the CN 32 is an International Mobile Telecommunications (IMT) CN such as a Third Generation Partnership Project (3GPP) CN. In other embodiments, the CN 32 may be, for example, another type of IMT CN such as a 3GPP2 CN (for Code Division Multiple Access (CDMA) based cellular systems), or an ETSI TISPAN (European Telecommunications Standards Institute TIPHON (Telecommunications and Internet Protocol Harmonization over Networks) and SPAN (Services and Protocols for Advanced Networks)) CN.

As shown in FIG. 1, the CN 32 may be a packet-switched (or packet-based) core network, which also may be referred to herein as a “Mobile Packet Core” or “MPC.” In one embodiment, the MPC 32 may be an Evolved Packet Core (EPC) of an LTE or LTE-A network. For ease of discussion, the terms “MPC” and “EPC” may be used interchangeably herein to refer to the all-IP, packet-based core network for LTE (or LTE-A). Previously, two separate and distinct core sub-domains—Circuit-Switched (CS) sub-domain for voice traffic and Packet-Switched (PS) sub-domain for data traffic—were used for separate processing and switching of mobile voice and data. However, in LTE, the EPC 32 unifies these two sub-domains as a single IP domain, thereby facilitating an end-to-end all-IP (packet-based) delivery of service in the LTE network (e.g., the carrier network 22)—from mobile handsets and other terminals with embedded IP capabilities, over IP-based eNodeBs, across the EPC, and throughout the application domain (including IP Multimedia Subsystem (IMS) as well as non-IMS domains).

Some exemplary functional elements (also interchangeably referred to herein as “network nodes” or “network entities”) constituting the EPC 32 may include a Policy and Charging Rules Function (PCRF) 44, an Access Network Discovery and Selection Function (ANDSF) 45, a Serving GPRS Support Node (SGSN) 46 (wherein “GPRS” refers to General Packet Radio Service), an Evolved Packet Gateway (EPG) 47, a Mobility Management Entity (MME) 48, and an Online Charging System (OCS) 49. As is understood, one or more of these network nodes may be implemented in software only or as a combination of hardware and software. Additional network nodes of the EPC 32 are not shown in FIG. 1 for the sake of simplicity.

The PCRF 44 may operate in real-time and aggregate information to and from the access network 30, operational support systems such as the MME 48 and the OCS 49, and other sources (not shown) to support the creation of rules and then automatically making policy decisions for each subscriber active in the carrier network 22. The operator may offer multiple services, Quality of Service (QoS) levels, and charging rules to its subscribers in the network 22. The PCRF 44 may enable a network operator to provide innovative service models to its subscribers and implement corresponding charging rules for services used/subscribed by the subscribers. The PCRF 44 may be deployed as a stand-alone entity or may be integrated with different platforms such as billing, rating, charging, and subscriber databases.

As its name implies, the ANDSF 45 may assist a UE to discover non-3GPP access networks—such as Wireless Fidelity networks (popularly known as “Wi-Fi” networks, such as an IEEE 802.11b Wireless Local Area Network (WLAN)) or WiMax networks—that can be used for data communications in addition to 3GPP access networks (e.g., HSPA or LTE) and to provide the UE with rules policing the connection to these networks.

The SGSN 46 may support the GPRS functionality in the CN 32 by providing delivery of data packets from and to the (GPRS-registered) mobile stations within its geographical service area. The SGSN 46 may perform packet routing and transfer, mobility management (attach/detach and location management), logical link management, and authentication and charging functions.

The EPG 47 may function as a gateway between the MPC 32 and other packet data networks, such as the Internet, corporate intranets, and private data networks. The EPG 47 may be alternatively referred to as an Evolved Packet Data Gateway (ePDG) and may function to secure the data transmission with a UE connected to the EPC 32 over an untrusted non-3GPP access. The EPG 47 may be deployed with Gateway GPRS Support Node (GGSN) functionality only, as a combination of Serving Gateway (S-GW) and Packet Data Network Gateway (PDN-GW) network elements in the EPC 32, or as a combination of GGSN, S-GW, and PDN-GW network elements in the EPC 32. As is known, a GGSN is generally responsible for internetworking between a GPRS network and an external packet-switched network, such as the Internet. An S-GW routes and forwards user data packets, while also acting as the mobility anchor for the user plane during inter-eNB handovers and as the anchor for mobility between LTE and other 3GPP technologies. The S-GW may manage and store UE contexts such as, for example, parameters of the IP bearer service, network internal routing information, etc. A PDN-GW (or PGW) may provide connectivity from the UE to external Packet Data Networks (PDNs) by being the point of exit and entry of traffic for the UE. A UE may have simultaneous connectivity with more than one PGW for accessing multiple PDNs. A PGW may perform policy enforcement, packet filtering for each user, charging support, packet screening, etc. A PDN-GW may also act as an anchor for mobility between 3GPP and non-3GPP technologies such as WiMAX and 3GPP2 based CDMA 1× and EV-DO.

The MME 48 may control all control plane functions related to subscriber and session management. Thus, the MME 42 may perform signaling and control functions to manage a UE's access to network connections, the assignment of network resources, and the management of the mobility states to support tracking, paging, roaming and handovers of UEs such as the UEs 24-28.

The OCS 49 is a system that allows a mobile network operator to charge its customers or mobile subscribers, in real-time, based on their service usage. The OCS 49 may be oriented to all subscriber types and service types, may offer unified online charging and online control capabilities, and also may be used as a unified charging engine for all network services, making it a core basis for convergent billing in the network 22.

As shown in FIG. 1, the MPC/EPC 32 may be connected to a Data Center (DC) 42, which may be an Internet-based service platform or service network hosting multiple virtualized applications (shown as 58-60, 62-64, and 66-68 in FIG. 1) or offering cloud-based services (not shown). In one embodiment, the DC 42 may be owned or operated by the operator of the carrier network 22. Alternatively, the DC 42 may be owned or operated by a third party Content Provider (CP) such as Amazon.com^{SM}, Google®, YouTube®, Netflix®, and the like, but subscribers of the carrier network 22 may be allowed access to the virtualized applications offered/supported by the DC 42 through appropriate service agreements between owner/operator of the DC 42 and the owner/operator of the mobile network 22. In the embodiment of FIG. 1, an SGi reference point 52 may connect the EPC 32 and the mobile carrier- or operator-specific DC 42. This SGi reference point may correspond to the Gi reference point for Second Generation (2G) or 3G accesses as indicated in FIG. 1. The SGi is the reference point between the EPC 32 (more specifically, in one embodiment, the EPG 47 in the EPC 32) and another Packet Data Network (PDN) (here, the carrier data center 42). The packet data network may be an operator-external public or private packet data network or an intra-operator packet data network, for example for provisioning of IMS services.

The carrier DC 42 may deploy virtualized applications or cloud-based services using Virtual Machines (VMs). In FIG. 1, three exemplary groups of VMs are shown using reference numerals 54-56. Each group may include three VMs, each identified by a pair of an instance of a virtualized application (“App”) and an instance of a corresponding Operating System (OS). Thus, the first group of VMs 54 includes three App-OS pairs 58-60, the second group of VMs 55 includes the other three App-OS pairs 62-64, and the third group of VMs 56 includes another three App-OS pairs 66-68. The App instances may be of the same virtualized application, for example a streaming video application, or may be instances of different virtualized applications, for example a streaming video application, an online shopping application, an online search engine, a remote gaming application, and the like invoked by one or more subscribers in the network 22.

As is known, a Virtual Machine (VM) is a software implementation of a machine (i.e., a computer) that executes programs like a physical machine. Thus, a VM is a software-based, fictive computer that may be based on specifications of a hypothetical computer or emulate the computer architecture and functions of a real world computer. Each VM instance can run any operating system supported by the underlying hardware. Thus, users can run two or more different “guest” operating systems simultaneously, in separate “virtual” computers or VMs. Virtual machines may be created using hardware virtualization that allows a VM to act like a real computer with an operating system. Software executed on these VMs is separated from the underlying hardware resources. Thus, for example, a computer that is running Microsoft Windows® operating system may host a virtual machine that looks like a computer with a Linux® operating system. In that case, Linux-based software can be run on the virtual machine. In hardware virtualization, the “host” machine is the actual machine/computer on which the virtualization takes place, and the “guest” machine is the VM. The words “host” and “guest” are generally used to distinguish the software that runs on the physical machine from the software that runs on the VM. In a cloud computing environment where virtualized applications may be routinely deployed, running multiple instances of virtual machines on shared computing resources/hardware such as the shared hardware 70-72 shown in FIG. 1 may lead to more efficient use of computing resources, both in terms of energy consumption and cost effectiveness. The shared hardware 70-72 may be from a single computer or may include hardware resources from a distributed computing environment.

The software or firmware that creates and runs a virtual machine on the host hardware is called a “hypervisor,” Virtual Machine Manager, or Virtual Machine Monitor (VMM). The VMM presents the guest operating systems with a virtual operating platform and manages the execution of the guest operating systems. Multiple instances of a number of different operating systems may share the virtualized hardware resources via the hypervisor. In FIG. 1, a hypervisor 74 creates and manages VM instances 58-60 on the shared hardware platform 70, a hypervisor 75 creates and manages VM instances 62-64 on the shared hardware platform 71, whereas a hypervisor 76 creates and manages VM instances 66-68 on the shared hardware platform 72.

Currently, virtual machine mobility (i.e., migration of a VM from one physical server to another) or mobility of a VM instance from one VM to another across Open Systems Interconnection (OSI) Layer-3 (L3) boundaries may be managed by a combination of a VM Management function 78 and a VM Mobility function 79 in the carrier DC 42. These VM management and VM mobility functions may be supported using technologies like Virtual eXtensible Local Area Network (VXLAN) or proprietary network controller software for cloud/virtualization such as, for example, VMware®, Inc.'s VMotion™ software or the vCider™ software from Cisco Systems®. These network controller software/technologies address the requirements of OSI L3 data center network infrastructure in the presence of VMs in a multi-tenant environment (e.g., when the data center provides services to multiple cellular operators or to multiple subscribers of a single operator) and support VM-to-VM communication. As a result, inter-DC or intra-DC VM mobility may be accomplished.

### SUMMARY

A critical deficiency in data centers today is related to VM mobility across OSI L3 boundaries. As shown in FIG. 1, the current placement of carrier DC 42 is completely separated from the carrier's mobile network 22. As a result, the VM Management 78 and VM Mobility 79 functions are independent of carrier's mobile network 22. Thus, a decision to move a subscriber's VM session between VMs (both intra-DC and inter-DC) is purely based on the hardware/software limitations of the carrier DC itself. As shown at reference numeral “80” in FIG. 1, although the carrier DC 42 is connected to the EPC 32 via SGi/Gi interface 52, the inputs from the carrier's mobile network 22 are not considered for the VM mobility (both intra-DC and inter-DC) even though the mobile network 22 (more specifically, the EPC 32 in the mobile network 22) is the entity that has the most relevant information about a subscriber's mobility and account preferences. Current technology also does not address the details of how such VM mobility may be controlled using the EPC.

It is therefore desirable to have inputs from a carrier's mobile network when moving a subscriber's VM instance between VMs (inter-DC or intra-DC). More specifically, given the EPC's knowledge of subscriber's preferences and roaming, it is desirable to have the EPC in the carrier's network—and not an external/remote data center—control the VM mobility for each subscriber to let the subscribers have the best user experience that the network can provide (in the context of cloud-based services or virtualized applications) and also enable the operators to deploy virtualized applications (e.g., telecom apps, IT apps, web-related apps, etc.) in an optimized way for their mobile subscribers.

Particular embodiments of the present disclosure provide for the EPC moving a subscriber's VM instance between VMs (intra-DC or inter-DC) based on the cellular network operator's policy, network load, subscriber's application requirement, subscriber's current location, subscriber's Service Level Agreement (SLA) with the operator, etc. In one embodiment, the present disclosure proposes to use GPRS Tunneling Protocol (GTP) tunnels rooted at the EPC to data center VMs to govern intra-DC and inter-DC mobility of VMs and also to tie in the mobility triggers to service provider's PCRF policies.

In one embodiment, each VM session for the mobile subscribers may be anchored in the EPG during the PDN session establishment (e.g., with a data center that may be an operator-external public or private packet data network or an intra-operator packet data network (e.g., for provision of IMS services)). The EPG may assume the control of VM mobility for each subscriber by establishing a new GTP interface with the VMs at a DC. The EPG may create a new GTP tunnel per PDN session per subscriber. Respective GTP Tunnel Identifier (ID), Access Point Name (APN), subscriber ID (e.g., the International Mobile Subscriber Identity (IMSI) number), subscriber-specific VM instance number, etc., may now have binding with each other within the EPG. The VMs, on the other hand, may also bind the subscriber-specific VM instance number with corresponding GTP Tunnel ID. In particular embodiments, the VM mobility (e.g., mobility of a subscriber-specific VM instance from one VM to another) may be triggered based on one or more of the following: (i) subscriber's location change, (ii) bandwidth and/or delay requirements associated with the (virtualized) application being used by the subscriber, (iii) SLA between the subscriber and the operator, (iv) change in the loading condition of the VMs in one or more DCs, and (v) network operator's charging rules for cloud-based services.

In one embodiment, the present disclosure is directed to a method for managing mobility of a subscriber-specific Virtual Machine (VM) instance from a first VM to a second VM for a mobile subscriber in a mobile communication network. The VM instance is initially created in the first VM that is implemented at a first Data Center (DC) associated with the mobile communication network. The method comprises performing the following using a network node in a packet-switched Core Network (CN) in the mobile communication network: (i) anchoring a VM session associated with the VM instance; and (ii) controlling the mobility of the subscriber-specific VM instance from the first VM to the second VM, wherein the second VM is implemented at either the first DC or at a second DC that is different from the first DC.

In another embodiment, the present disclosure is directed to a network node in a packet-switched CN in a mobile communication network for managing mobility of a subscriber-specific VM instance from a first VM to a second VM for a mobile subscriber in the mobile communication network. The VM instance is initially created in the first VM that is implemented at a first DC associated with the mobile communication network. The network node is configured to perform the following: (i) anchor, in the network node, a VM session associated with the VM instance; and (ii) control the mobility of the subscriber-specific VM instance from the first VM to the second VM, wherein the second VM is implemented at either the first DC or at a second DC that is different from the first DC.

In a further embodiment, the present disclosure is directed to a system for managing mobility of a subscriber-specific VM instance from a first VM to a second VM for a mobile subscriber in a mobile communication network. The system comprises: (i) a first DC associated with the mobile communication network and implementing the first VM, wherein the VM instance is initially created at the first VM; (ii) a second DC associated with the mobile communication network, wherein the second DC is in communication with the first DC and is different from the first DC; and (iii) an Evolved Packet Core (EPC) of the mobile communication network coupled to the first DC and the second DC, wherein the EPC is configured to perform the following: (a) anchor a VM session associated with the VM instance, and (b) control the mobility of the subscriber-specific VM instance from the first VM to the second VM, wherein the second VM is implemented at either the first DC or at the second DC.

Thus, the EPC-based control of VM mobility in certain embodiments of the present disclosure lets the subscribers use applications that require low latency and/or high bandwidth (e.g., multimedia streaming and real-time gaming applications) and, hence, have the best user experience that the network can provide. This can provide optimization of cloud services accessed by a subscriber over a mobile connection. Thus, cellular network operators can deploy virtualized applications in an optimized way for their mobile subscribers. The operator could optimize both for the mobile end point (i.e., a subscriber's UE) and the VM DC positions (intra-DC as well as inter-DC).

### BRIEF DESCRIPTION OF THE DRAWINGS

In the following section, the present disclosure will be described with reference to exemplary embodiments illustrated in the figures, in which:

FIG. 1 illustrates an exemplary network configuration showing how virtualized applications and cloud-based services are currently deployed for subscribers in a mobile communication network;

FIG. 2 is a diagram of an exemplary wireless system in which the VM mobility methodology according to the teachings of one embodiment of the present disclosure may be implemented;

FIG. 3 depicts an exemplary flowchart showing various steps that may be performed by a network node in an EPC to control VM mobility according to the teachings of particular embodiments of the present disclosure;

FIG. 4 shows details of a portion of the wireless system in FIG. 2 in which the VM mobility solution according to the teachings of one embodiment of the present disclosure may be implemented;

FIG. 5 shows a high level sequence diagram of the initial binding between an EPG and a DC-based VM (where a subscriber-specific VM instance is created);

FIGS. 6A and 6B illustrate an exemplary sequence diagram (or message flow) related to a bandwidth-based VM mobility trigger according to one embodiment of the present disclosure;

FIGS. 7A and 7B depict an exemplary message flow or sequence diagram related to latency delay- and UE location-based VM mobility trigger according to one embodiment of the present disclosure;

FIGS. 8A through 8C illustrate exemplary configurations regarding how to provide appropriate network connectivity between an operator's core network and a data center to support the VM mobility solution according to particular embodiments of the present disclosure; and

FIG. 9 depicts a block diagram of an exemplary network node in a core network through which the VM mobility solution according to particular embodiments of the present disclosure may be implemented.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. It should be understood that the disclosure is described primarily in the context of a 3GPP (e.g., LTE) cellular telephone/data network, but it can be implemented in other forms of cellular or non-cellular wireless networks as well.

In the discussion herein, the terms “VM mobility” or “virtual machine mobility” are primarily used to refer to mobility of a VM instance from one VM to another. However, these terms may also broadly refer to migration of a VM from one physical server to another depending on the context of discussion or implementation. Thus, although the discussion below is given primarily in the context of controlling mobility of a subscriber-specific VM instance, such discussion is exemplary in nature and should not be construed as limiting applicability of the solution in particular embodiments of the present disclosure to controlling mobility of VM instances only. Rather, the teachings in particular embodiments of the present disclosure may equally apply to situations that require control of mobility of VMs or different types of VM implementations.

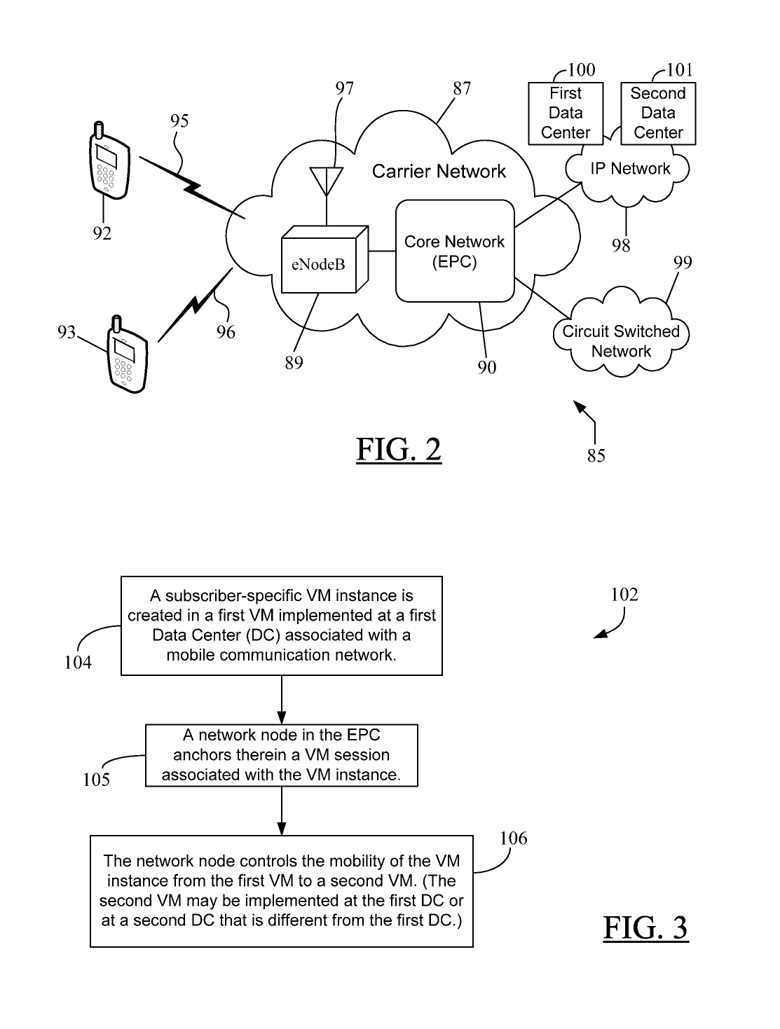

FIG. 2 is a diagram of an exemplary wireless system 85 in which the VM mobility methodology according to the teachings of one embodiment of the present disclosure may be implemented. The system 85 is shown to include a cellular carrier network (or mobile communication network) 87 having a base station 89 and a Core Network (CN) 90. When the carrier network 87 is an LTE network, the base station 89 may be an eNodeB and the CN 90 may be a packet-switched CN (i.e., an EPC). Two exemplary mobile units 92-93 representing mobile subscribers operating in the network 87 are shown to be in wireless communication via respective radio links 95-96 with the carrier network 87 through the base station 89, which is interchangeably referred to herein as a “mobile communication node,” or simply a “node” of the network 87. The network 87 may be operated, managed, and/or owned by a wireless service provider or operator. As mentioned earlier, the base station 89 may be, for example, a base station in a 3G network, or an evolved Node-B (eNodeB or eNB) when the carrier network is an LTE network, and may provide a radio interface (e.g., an RF channel) to the wireless devices 92-93 via an antenna or antenna unit 97. The radio interface is depicted by the exemplary wireless links 95-96. On the other hand, when the carrier network 87 is a 3GPP2's CDMA-based EV-DO network, the base station 89 may be an evolved Base Transceiver Station (eBTS). Additionally, the base station 89 and the Core Network 90 may support WiFi access network technology.

In case of a 3G carrier network 87, the mobile communication node 89 may include functionalities of a 3G base station along with some or all functionalities of a 3G Radio Network Controller (RNC). In other embodiments, the base station 89 may also include a site controller, an access point (AP), a radio tower, or any other type of radio interface device capable of operating in a wireless environment. In one embodiment, the base station 89 may be configured to implement an intra-cell or inter-cell Coordinated Multi-Point (CoMP) transmission/reception arrangement. In addition to providing the air interface or wireless channel, as represented by wireless links 95-96 in FIG. 2, to the devices 92-93 via antenna 97, the communication node (or base station) 89 may also perform radio resource management (as, for example, in case of an eNodeB in an LTE system) using, for example, the channel feedback reports received from the wireless devices 92-93 operating in the network 87.

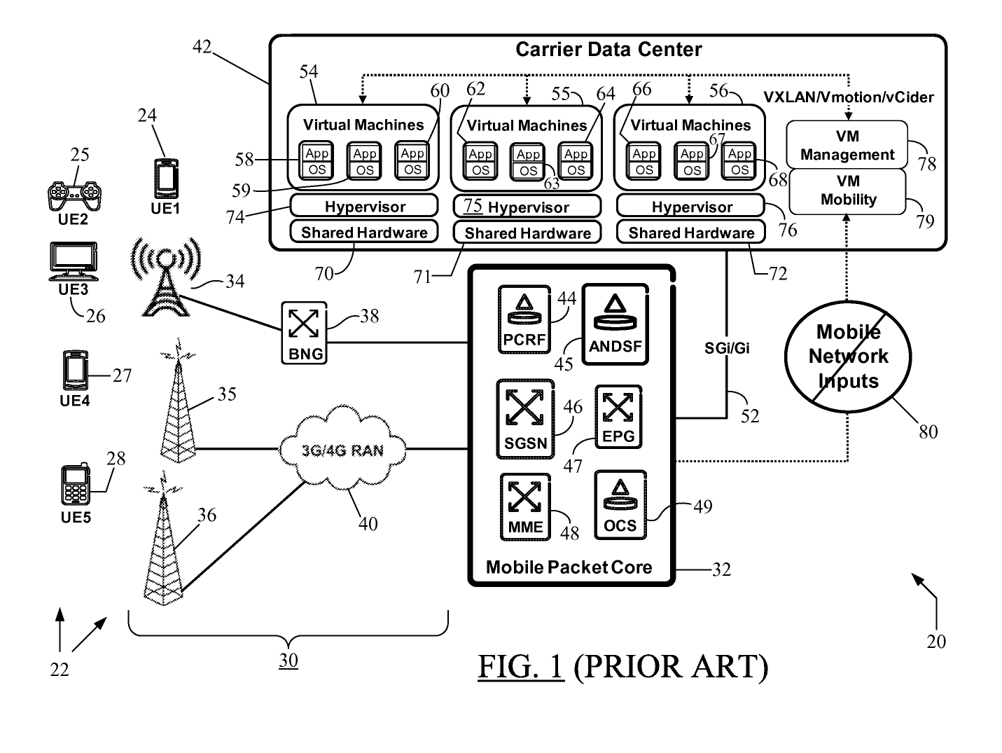

The wireless devices 92-93 in FIG. 2 are similar to the wireless devices 24-28 in FIG. 1 and, hence, earlier discussion of devices 24-28 remains applicable here and is not repeated herein for the sake of brevity. In summary, like the wireless devices 24-28 in FIG. 1, each of the wireless devices 92-93 in FIG. 2 also may be a UE, or an MS, or an AT (or evolved AT). Generally, the wireless devices 92-93 may be any multi-mode mobile handsets enabled for communications over a number of different RATs. Because examples of different types of “wireless devices” are already provided earlier under the “Background” section, such examples are not repeated herein for the sake or brevity. As noted earlier, for the sake of simplicity, in the discussion herein, the term “UE” may be primarily used as representative of all such wireless devices (i.e., AT's, MS's, or other mobile terminals), regardless of the type of the network 87 (i.e., whether a 3GPP network, a 3GPP2 network, a WiFi network, etc.) in which these devices are operational.

In the discussion herein, the terms “wireless network,” “mobile communication network,” “operator network,” or “carrier network” may be used interchangeably to refer to a wireless communication network (e.g., a cellular network, a proprietary data communication network, a corporate-wide wireless network, a WiFi network, etc.) facilitating voice and/or data communication with wireless devices (like the devices 92-93). The wireless network 87 may be a dense network with a large number of wireless terminals such as UEs operating therein. It is understood that there may be stationary devices such as M2M devices as well as mobile devices such as mobile handsets/terminals operating in the network 87.

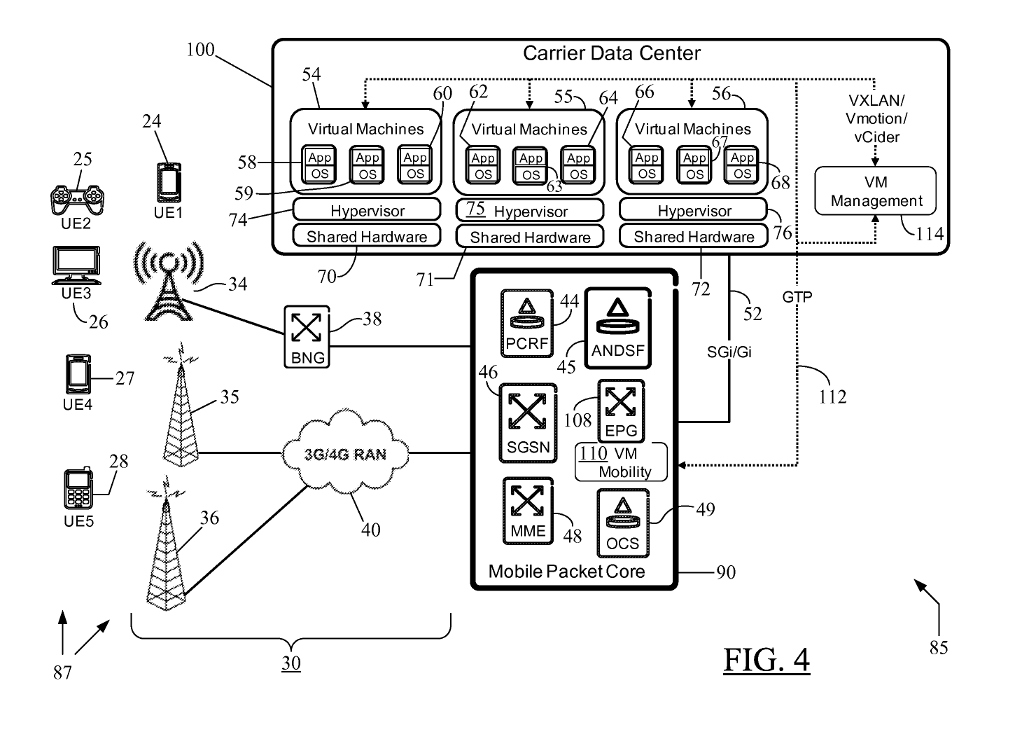

Like the mobile communication network 22 in FIG. 1, the carrier network 87 in FIG. 2 may also include the CN 90 as a network controller coupled to the base stations in its RANs (not shown) and providing logical and control functions, for example terminal mobility management, access to external networks or communication entities, subscriber account management, and the like in the network 87. Like the CN 32 in FIG. 1, the CN 90 also may be an EPC and, hence, the earlier EPC-related discussion in the “Background” section remains applicable to the EPC 90 as well and such discussion is not repeated herein for the sake of brevity. However, the CN 90 in FIG. 2 is distinguishable from the CN 32 in FIG. 1 in that the CN 90 may also be configured to control VM mobility as per the teachings of particular embodiments of the present disclosure (discussed in more detail later below). Regardless of the type of the carrier network 87, the CN 90 may function to provide connection of the base station 89 to other terminals (not shown) operating in the base station's radio coverage area, and also to other communication devices such as wireline or wireless phones, computers, monitoring units, and so on or resources (e.g., an Internet website) in other voice and/or data networks (not shown) external to the carrier network 87. In that regard, the network controller or CN 90 may be coupled to a packet-switched network such as an IP network 98 as well as a circuit-switched network 99, such as the Public-Switched Telephone Network (PSTN), to accomplish the desired connections beyond the carrier network 87. As shown in FIG. 2, one or more data centers (two of which are indicated by reference numerals “100” and “101” in FIG. 2) associated with the carrier network 87 and communicatively coupled to it may reside in the IP network 98, which may be the Internet. These data centers 100-101 may be in communication with each other, and may host virtualized applications and may provide cloud-based services to the network's subscribers. For ease of discussion herein, only the data center 100 is shown in subsequent figures and discussed in more detail. However, it is noted that the discussion of data center 100 equally applies to the DC 101 and other such data centers (not shown) that may be associated with the carrier network 87. The data center 100 may be substantially similar to the DC 42 in FIG. 1, but different from the DC 42 in that the data center 100 may no longer support the VM Mobility function 79 but still accomplish VM mobility through its connection to the EPC 90 via a GPRS Tunneling Protocol (GTP) tunnel as discussed later with reference to discussion of FIG. 4.

The operator network 87 may be a cellular telephone network, a Public Land Mobile Network (PLMN), or a non-cellular wireless network providing voice, data, or both. The wireless devices 92-93 may be subscriber units in the operator network 87. Furthermore, portions of the operator network 87 may include, independently or in combination, any of the present or future wireline or wireless communication networks such as, for example, the PSTN, an IMS based network, or a satellite-based communication link. Similarly, as also mentioned above, the carrier network 87 may be connected to the Internet via its CN's connection to the IP network 98 or may include a portion of the Internet as part thereof. In one embodiment, the operator network 87 may include more or less or different type of functional entities than those shown in FIG. 2.

The CN 90 may be configured as discussed below to control VM mobility according to particular embodiments of the present disclosure. For example, in one embodiment, the CN 90 may be configured in hardware or a combination of hardware and software to implement the VM mobility solution as discussed herein. For example, when existing hardware architecture of the CN 90 cannot be modified, the VM mobility solution according to one embodiment of the present disclosure may be implemented through suitable programming of one or more processors in a network node of the CN 90 (e.g., the processor 235 in the CN's EPG 108 in FIG. 9). The execution of the program code by the processor 235 in the EPG 108 may cause the processor to perform appropriate method steps—e.g., anchoring of a VM session associated with a subscriber-specific VM instance, controlling the mobility of the VM instance from one VM to another, etc.—which are illustrated in more detail in FIGS. 3 and 5-7, discussed below. Thus, in the discussion below, although the EPC 90 (and more particularly, the EPG 108 in the embodiment of FIG. 4) may be referred to as “performing,” “accomplishing,” or “carrying out” a function or a process, such performance may be technically accomplished in hardware and/or software as desired.

Although various examples in the discussion below are provided primarily in the context of an IP-based (i.e., packet-switched) core network such as an EPC in a 3GPP LTE system, the teachings of the present disclosure may equally apply, with suitable modifications, to core networks or functionally similar entities in a number of different Frequency Division Multiplex (FDM) and Time Division Multiplex (TDM) based cellular wireless systems or networks, as well as Frequency Division Duplex (FDD) and Time Division Duplex (TDD) wireless systems/networks. Such cellular networks or systems may include, for example, 3GPP or 3GPP2 standard-based systems/networks using Second Generation (2G), 3G, or Fourth Generation (4G) specifications, or non-standard based systems. Some examples of such systems or networks include, but not limited to, GSM networks, GPRS networks, Telecommunications Industry Association/Electronic Industries Alliance (TIA/EIA) Interim Standard-136 (IS-136) based Time Division Multiple Access (TDMA) systems, WCDMA systems, WCDMA-based HSPA systems, 3GPP2's CDMA based High Rate Packet Data (HRPD) or evolved HRPD (eHRPD) systems, CDMA2000 or TIA/EIA IS-2000 systems, Evolution-Data Optimized (EV-DO) systems, WiMAX systems, International Mobile Telecommunications-Advanced (IMT-Advanced) systems (e.g., LTE Advanced systems), other Universal Terrestrial Radio Access Network (UTRAN) or Evolved UTRAN (E-UTRAN) networks, GSM/EDGE systems, Fixed Access Forum or other IP-based access networks, a non-standard based proprietary corporate wireless network, etc. It is noted that the teachings of the present disclosure are also applicable to FDM variants such as, for example, Filter Bank Modulation option, as well as to multiple access schemes based on spatial division such as Spatial Division Multiple Access (SDMA).

FIG. 3 depicts an exemplary flowchart 102 showing various steps that may be performed by a network node in an EPC (e.g., the EPC 90 in FIGS. 2 and 4) to control VM mobility according to the teachings of particular embodiments of the present disclosure. In one embodiment, that network node may be an EPG (e.g., the EPG 108 in FIG. 4). Initially, at block 104, a subscriber-specific VM instance is created in a first VM implemented at a first DC associated with the mobile communication network (e.g., the DC 100 associated with the network 87 in FIG. 2). The first DC may create the VM instance when a mobile subscriber “runs” a virtualized application on the subscriber's UE or invokes a cloud-based service using the UE. As noted earlier, the virtualized application or the cloud-based service may be offered, supported, or administered by a Content Provider (CP) (such as, for example, Amazon.com^{SM}, Google®, YouTube®, Netflix®, etc.) through the respective data center associated with the carrier's network 87. The EPG in the EPC may become aware of the creation of the VM instance and may identify the corresponding application (e.g., a mobile gaming application, a streaming video download application, an online shopping application, etc.) used by the subscriber. Then, at block 105, the EPG may anchor therein a VM session associated with the subscriber-specific VM instance. After the VM session is anchored in the EPG, the EPG maintains control over the mobility of the VM instance from the first VM to a second VM (which may be implemented at the first DC or at a second DC 101 that is different from the first DC) as indicated at block 106. Thus, instead of a DC-based VM mobility control (as in the embodiment of FIG. 1), the present disclosure provides for an EPC-based VM mobility control. Additional details of anchoring of a VM session in the EPG and EPG's subsequent control of the VM mobility are provided below with reference to discussion of FIGS. 4-7.

FIG. 4 shows details of a portion of the wireless system 85 in FIG. 2 in which the VM mobility solution according to the teachings of one embodiment of the present disclosure may be implemented. For ease of comparison, the system 85 in FIG. 4 is depicted in a manner analogous to the network configuration 20 in FIG. 1—with entities having similar configurations or functionalities in these two figures being identified using the same reference numerals for the sake of simplicity and ease of discussion. Hence, the earlier discussion of such entities, for example UEs 24-28, the AN portion 30, PCRF 44, MME 48, groups of VMs 54-56, hypervisors 74-76, and the like, with reference to FIG. 1 remains applicable in the context of FIG. 4 and, therefore, is not reproduced in detail below. Although the wireless system 85 shows UEs 92-93 in FIG. 2, these UEs 92-93 may be considered as representatives of UEs 24-28 in FIGS. 1 and 4. Similarly, for ease of depiction, although a single base station 89 is shown in FIG. 2 as part of the carrier network 87 of the system 85, this base station 89 also may be considered as representative of different types of base stations such as base stations 34-36 shown in FIGS. 1 and 4.

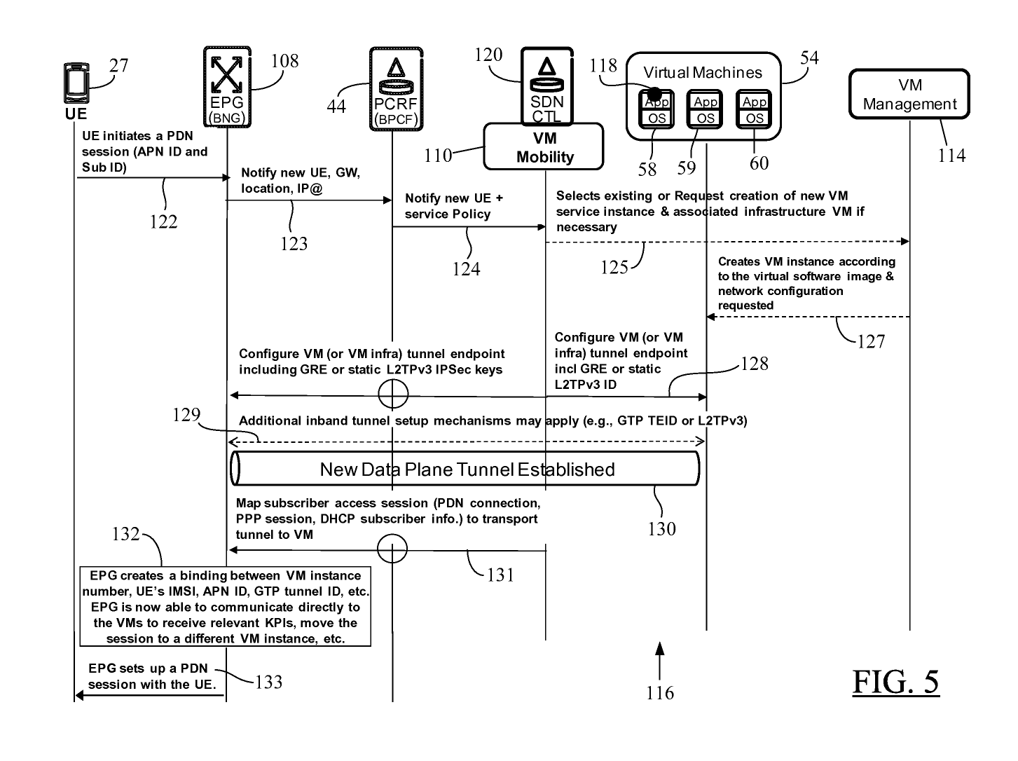

There are, however, certain differences between the wireless system 85 in FIG. 4 and the network configuration 20 in FIG. 1. For example, the carrier network 87 is different from the carrier network 22 in FIG. 1 in that the EPC 90 in the carrier network 87 is configured to control VM mobility as per teachings of particular embodiments of the present disclosure. No such capability exists in the EPC 32 in FIG. 1. Thus, in the embodiment of FIG. 4, one of the network nodes in the EPC 90—i.e., an EPG 108—is modified/configured to perform such VM mobility control. (The EPG 47 in FIG. 1 does not have such capability.) It is understood that instead of the EPG 108, some other network node in the packet-switched CN 90 also may be similarly configured to implement the CN-based VM mobility control solution as per particular embodiments of the present disclosure. Consequently, a VM mobility function 110 is merged with the EPG 108. This VM mobility function 110 may be a modified version of the DC-based VM mobility function 79 in FIG. 1 to support the EPG-anchored GTP tunneling 112 (described later). In view of the new GTP tunnel 112 between the EPG 108 and VMs 54-56 in the DC 100, a modified VM management function 114 may be implemented in the DC 100 to support the GTP tunnel-based VM mobility solution. A similar VM management function (not shown) may be implemented at the DC 101. In one embodiment, the VM management function 114 may be external to the DC 100 and, in that case, the VM Management function 114 may be shared by multiple DCs (i.e., the VM management function 114 may be in communication with DCs 100 and 101 in FIG. 2). In one embodiment, the groups of VMs 54-56, corresponding hypervisors 74-76, and shared hardware 70-72 may remain substantially similar between the configurations in FIGS. 1 and 4. Additional details of the EPC-based VM mobility control are provided below (in FIGS. 5-7) with reference to the configuration in FIG. 4.

In the context of FIG. 4, the following aspects describe how an EPC-based control over VM mobility may be accomplished. No specific order of implementation is implied in the presentation below.

(a) As noted earlier, the VM mobility function 110 may be merged with the EPG 108. In one embodiment, the VM mobility function 110 may provide a 3GPP interface to the GTP tunnel 112 (discussed later) and may enable the EPG 108 to exercise control over mobility of a subscriber-specific VM instance from one VM to another. In an alternative embodiment, the VM mobility function 110 may not be part of the EPG 108, but may be a separate network entity or functional element in the EPC 90 communicating with the EPG 108 (or any other network node in the EPC 90 selected to implement VM mobility control) via a suitable 3GPP interface.

(b) In one embodiment, the EPC-based VM mobility control is facilitated via a new GTP interface/tunnel 112 between the EPG 108 and the groups of virtual machines 54-56 (and, hence, between the EPG 108 and group-specific individual VMs 58-60, 62-64, and 66-68). In other words, the EPG 108 may exercise control over VM mobility of each subscriber through this GTP tunnel 112 with the VMs in the DC 100. In other embodiments, different types of tunnels or interfaces may be implemented to maintain CN's control over VM mobility. For example, in case of a 3GPP2 core network, a Generic Routing Encapsulation (GRE) tunnel may be used instead of the GTP tunnel discussed herein. In the embodiment of FIG. 4, the new GTP interface 112 may be used by the EPG 108 to retrieve the loading condition of individual VMs at any given instance. It is noted here that in case of a 3GPP2 (i.e., CDMA) based RAN architecture, a new Mobile IP interface between a Packet Data Serving Node (PDSN) (not shown) and the VM Management function 114 may perform the same function. As is known, a PDSN may perform packet routing and mobility management in a CDMA network (not shown).

(c) The same GTP interface/tunnel 112 may also exist between the EPG 108 and the VM Management function 114 as shown in FIG. 4. This interface 112 may be used by the EPG 108 to instruct the VM Management function 114 to create, move, and delete a VM instance for a specific subscriber. Thus, in one embodiment, a new GTP tunnel may be created, for example by the EPG 108 in the embodiment of FIG. 4, per PDN session per subscriber. In case of a 3GPP2-based RAN architecture, the above-mentioned Mobile IP interface between a PDSN and the VM Management function 114 may fulfill the same objectives.

(d) Each of the VMs (i.e., VMs 58-60, 62-64, etc. in the DC 100) and the VM Management function 114 (in the DC 100) may now create a corresponding binding between the GTP tunnel ID, which may be assigned to the GTP tunnel 112 by the EPG 108, and a VM instance number assigned by the VM hosting the subscriber-specific VM instance or by the VM Management function 114 of the subscriber-specific VM instance. Thus, although there may be a single GTP tunnel ID, there may be multiple individual bindings to this tunnel ID—each VM and the VM management function having its own binding to the GTP tunnel ID.

(e) The EPG 108 may also create a binding among the respective subscriber ID (e.g., the subscriber UE's IMSI number, or the UE's Mobile Subscriber Integrated Services Digital Network (MS-ISDN) number, etc.), the GTP tunnel ID, the subscriber-specific VM instance number, an APN ID of a gateway or a Packet Data Network that the subscriber UE may want to use for its PDN session, and the like.

(f) As discussed so far, in one embodiment, each mobile subscriber may have a GTP tunnel created per PDN session initiated by the subscriber. As a result of the above-described bindings, the VM session of each mobile subscriber may be now anchored at the EPG 108 during the PDN session establishment. Each VM session is associated with a respective subscriber-specific VM instance. A VM session is considered “anchored” at the EPG 108 because the EPG 108 has the necessary information (e.g., information related to routing, required Quality of Service (QoS), subscriber billing/charging policy, and so on) needed to transfer the VM session (i.e., the subscriber-specific VM instance associated with the VM session) from one VM to another as discussed later below.

(g) The EPG 108 can now control the VM mobility. In one embodiment, the EPG 108 may exercise such control using the VM mobility function 110. As part of controlling the mobility of a subscriber-specific VM instance, the EPG 108 may instruct the VM management function 114, for example via the GTP tunnel 112, to create, move, or delete a VM instance at a VM for a specific subscriber. In another embodiment, the EPG 108 may instruct the VM management function 114 to move, scale up (e.g., with more computing, storage, and/or networking resources than the current VM instance), or replicate the subscriber-specific VM instance from one VM to another. In certain embodiments, the EPG 108 may control VM mobility by triggering VM mobility based on certain “triggers” (discussed below).

There are options available to the EPG 108 for identifying the virtualized or cloud-based application used by the subscriber (on the subscriber's UE). Such identification may be necessary to determine, for example, whether the application is a low-latency and/or high bandwidth application which requires additional processing resources. Such determination may further assist the EPG in making a decision as to how to handle the mobility of a VM instance associated with that application. For example, if the application uses only audio data, that is, voice packets as opposed to bandwidth-intensive multi-media content, then no special treatment may be necessary for such an application. The following are three exemplary EPG options for identifying the application used by the subscriber:

(i) To identify the application used by the subscriber, in one embodiment, the EPG 108 may perform the Deep Packet Inspection (DPI) function within the EPG itself. The DPI function allows the EPG to analyze the network traffic from the subscriber UE to discover the type of the application that sent the data. In order to prioritize traffic or filter out unwanted data, deep packet inspection can differentiate data such as video, audio, chat, Voice over IP (VoIP), e-mail, and Web browsing. For example, the DPI function can determine not only that the data packets contain the contents of a web page, but also which website the page is from. Using the DPI function, the EPG 108 may look at the payload (of a data packet received from the subscriber UE) and get control information from it. Such control information may include, for example, an App ID identifying the application being used by the subscriber UE, destination IP address such as the IP address of the carrier DC 100, payload information (for example, type of the payload—whether a voice packet, a video packet, or a text data packet), and the like. Through the DPI function, the EPG 108 may also identify the Content Provider (CP) (e.g., Verizon®, YouTube®, Google®, Netflix®, etc.) that has contractual or service-level relation with the operator of the network 87 to provide content delivery services to operator's subscribers at one or more QoS levels.

(ii) In another embodiment, the CP may itself send the application information to the EPG 108 via Representational State Transfer (REST)/Web Services interface to the EPG based on the Service Level Agreement (SLA) between the CP and the operator of the carrier network 87.

(iii) In a further embodiment, other DPI node (not shown) within the operator's network 87 may inform the EPG 108 of the identity of the application used by the subscriber via REST/Web Services interface or by Hypertext Transfer Protocol (HTTP) header enrichment or by a proprietary messaging interface.

In one embodiment, the VM mobility (e.g., mobility of a subscriber-specific VM instance from one VM to another VM) may be triggered by the EPG 108 or by the VM Mobility function 110 in the EPG 108 based on one or more of the following exemplary “triggers”:

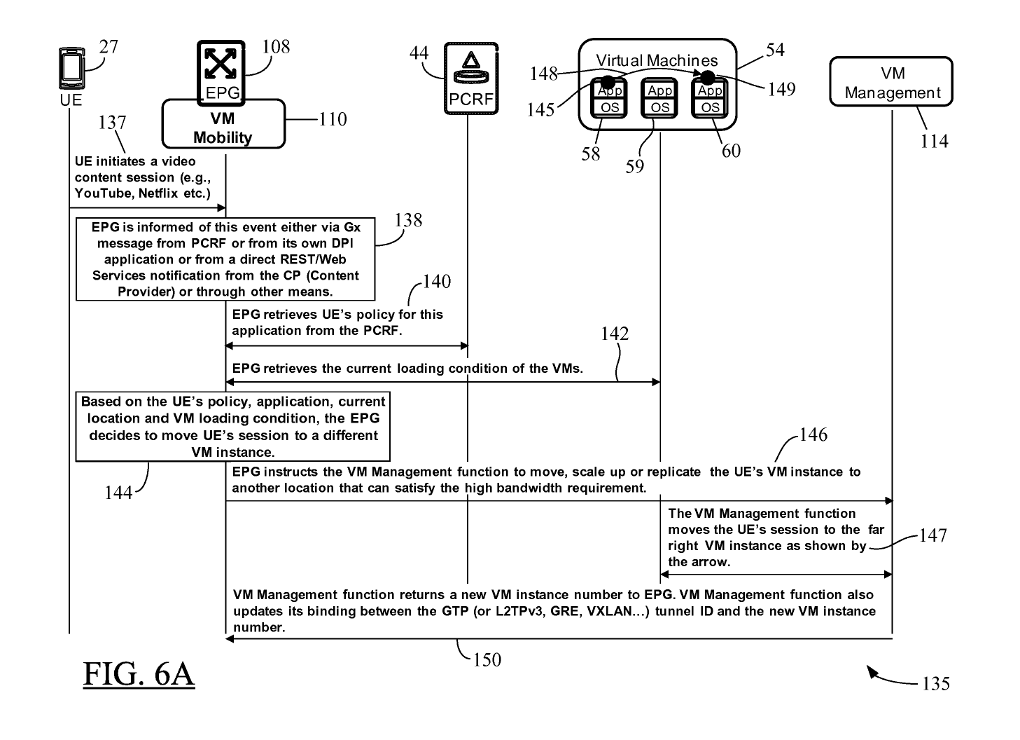

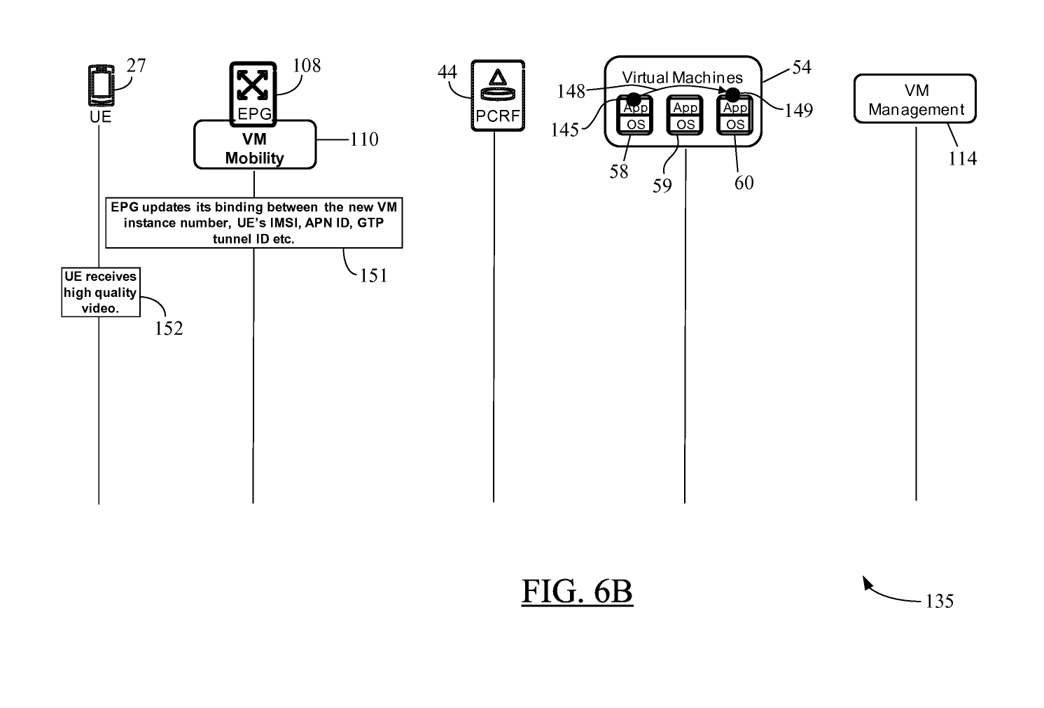

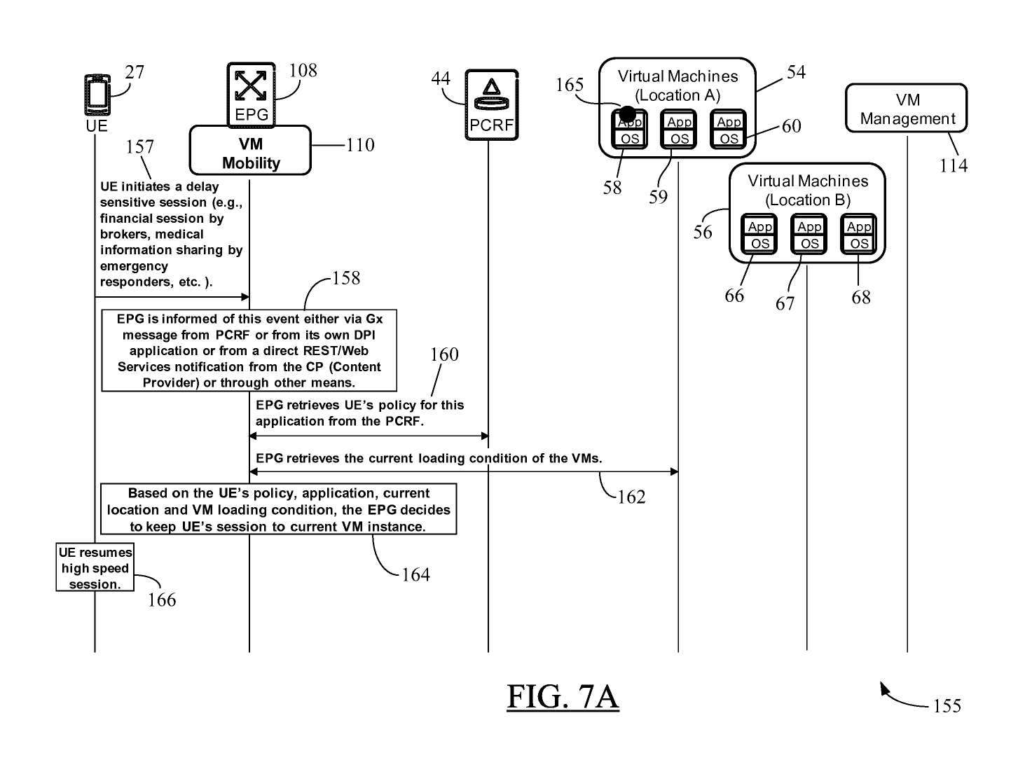

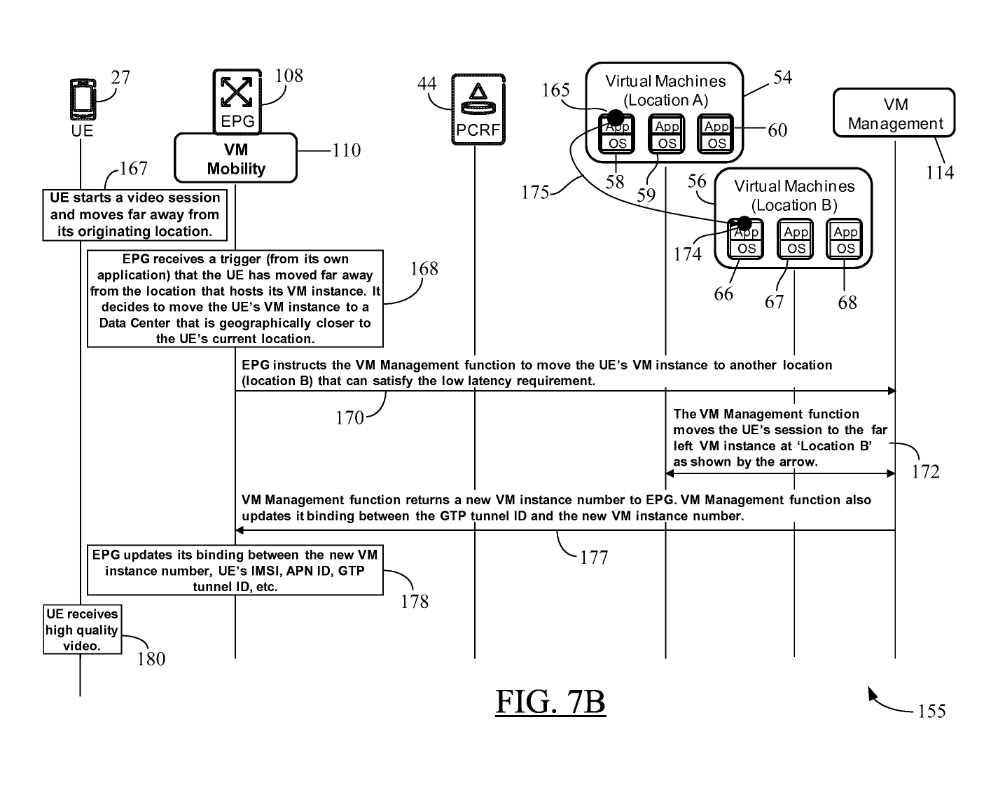

(i) A requirement associated with a mobile application being used by the mobile subscriber (as discussed later with reference to the exemplary embodiments of FIGS. 6-7). In one embodiment, this requirement may be specified in a subscriber-specific PCRF policy associated with the mobile application. The requirement may specify a radio bandwidth threshold such as the minimum bandwidth needed for the application and/or a latency delay threshold such as how much latency is tolerable for the application.

(ii) A change in geographical location of the mobile subscriber (as discussed later with reference to the exemplary embodiment of FIG. 7).

(iii) An SLA between the mobile subscriber and the operator of the carrier network 87. Such SLA may provide for provisioning of a certain level of QoS, bandwidth, and latency delay for subscriber-selected applications.

(iv) A change in the loading condition of the VMs in one or more DCs.

(v) The network operator's charging rules for cloud-based services. For example, applications with premium content, for example online gaming or streaming video apps, or apps dealing with real-time financial transactions, may be charged extra by the network operator. In that case, VM mobility may be triggered whenever a need arises to satisfy the high bandwidth/low latency requirements of these applications so that the operator may continue to charge extra for these premium services.

In another embodiment, there may be other possible (VM mobility) triggers for subscriber connectivity change to alternate VM. Some examples of these triggers may include one or more of the following:

(i) A change in availability of hardware resources for the VM where the subscriber-specific VM instance is created. For example, hardware maintenance may prompt a change in hardware availability, thereby requiring moving the current VM instance of the subscriber application to another VM.

(ii) A change in an SLA between the operator of the mobile communication network 87 and the owner of the VM where the subscriber-specific VM instance is created. It is noted here that the owner of the DC 100 (where VMs are hosted) may be different from the operator of the DC 100. Also, there may be different owners for different VMs in the DC 100. Furthermore, the network operator may not be the owner of the VMs in the DC 100. In that case, an SLA between the network operator and the owner(s) of the VMs may govern the treatment of network operator's subscribers with regard to virtualized applications (or cloud-based services) supported through the VMs in the DC 100. In one embodiment, the SLA between the network operator and an owner of one or more VMs in the DC 100 may change, for example, when the owner of a VM resells the VM to a Third Party Partner (3PP) (for example a service/content provider like YouTube®, Pandora® radio, and the like), or an Over-The-Top (OTT) content provider such as Google®, Vonage®, or Skype™. Such reselling may include reselling of Content Delivery Network (CDN) caches. In one embodiment, the DC 100 and its servers or shared hardware may be part of a CDN and CDN caches may be associated with VMs hosted at the DC 100.

(iii) A change in the network topology of the mobile communication network 87. The owner or operator of the network 87 may change the topology of its network 87, for example, to optimize IP transport layer to take advantage of (geographically) closer Internet peering points or to provide for an optimized optical transport sub-layer. Such topological changes may necessitate relocation of VM instances of certain subscribers to more efficiently manage network traffic over the new topology.

(iv) A new service subscribed by the mobile subscriber from the operator of the mobile communication network 87. Such new service may require, for example, additional bandwidth that may not be supported by the current subscriber-specific VM instance. In that case, VM instance relocation may be triggered by the EPG 108.

(v) A need to control power consumption, for example, of the current VM where the subscriber-specific VM instance is created and/or the VM to which the VM instance is to be moved. For example, in one embodiment, VM instances may be consolidated to a larger, more centralized VM at night to efficiently manage power consumption of both the VMs—the originating VM as well as the destination VM. The issue of control of power consumption may also arise in the context of earlier-mentioned change in the loading condition of the VMs in one or more DCs.

FIGS. 5-7 illustrate some exemplary message flows or sequence diagrams related to the CN-based VM mobility control solution according to particular embodiments of the present disclosure. Various network nodes or entities in these figures are shown in the context of FIG. 4. In FIGS. 5-7, the control of VM mobility is illustrated using one of the UEs (i.e., the UE 27) from FIG. 4 as an example. However, it is understood that the VM instances of other UEs in the carrier network 87 may be similarly managed/controlled. Also, the VM mobility examples in FIGS. 5-7 are illustrated using the VM groups 54 and 56 as examples only. The message flows in FIGS. 5-7 equally apply to other VM groups or data centers other than the DC 100 in FIG. 4. Furthermore, as noted earlier, in one embodiment, the VM mobility function 110 may configure the EPG 108 to perform various EPG-based actions depicted in FIGS. 5-7, regardless of whether the VM mobility function 110 is implemented at the EPG or elsewhere. In another embodiment, however, the EPG 108 itself may be configured and/or designed to perform such actions without necessarily being dependent on the VM mobility function 110. Additionally, for ease of representation, a subscriber-specific VM instance may be symbolically represented by a large black dot, like dot 118 in FIG. 5, dot 145 in FIG. 6, and dots 165 and 174 in FIG. 7.

FIG. 5 shows a high level sequence diagram 116 of the initial binding between an EPG such as the EPG 108 in FIG. 4 and a DC-based VM such as the VM 58 where a subscriber-specific VM instance 118 is created. This initial binding sequence may take place, for example, when a UE initiates its first PDN session in the carrier network 87. Such UE may be considered as a “new” UE in the context of setting up the initial binding. In the embodiment of FIG. 5, the VM Mobility function 110 is shown to be part of a Software Defined Networking Controller (SDN CTL) 120 and not as part of the EPG 108 to illustrate how flexibly the CN-based control over VM mobility may be accomplished using teachings of particular embodiments of the present disclosure. It is understood that, in one embodiment, the VM mobility function 110 may not have to be a part of the SDN controller 120, which may already exist in the carrier network 87, but may be implemented at the EPG 108 or elsewhere in the EPC 90. In one embodiment, the SDN controller 120 may be implemented in the EPG 108 along with the VM mobility function 110, which may result in the EPG configuration similar to that shown in FIG. 4. However, broadly speaking, the SDN controller 120, with or without the VM mobility function 110, may be implemented anywhere in the carrier network 87 (FIG. 4) including, for example, in a node in the CN 90 other than the EPG 108 or within a node in the access network 30. In any event, if SDN controller 120 is implemented with VM mobility function 110, then it may be preferable to implement it as part of the CN 90 to effectively support the CN-based VM mobility control as per teachings of particular embodiments of the present disclosure. It is understood that an SDN controller is an application in software-defined networking that manages flow control to enable intelligent networking. SDN controllers are based on protocols, such as OpenFlow (OF), that allow servers to tell network switches where to send packets. In one embodiment, all communications between virtualized applications (e.g., applications deployed at the DC 100) and network devices (e.g., the UE 27) may go through the SDN CTL 120, which may choose the optimal network path for application traffic. Typically, network routers may implement a control plane with control information or routing tables indicating how to route a data packet, and a user plane for handling user data packets to be routed according to the control information. An SDN controller may separate the control plane off the network hardware, such as the EPG 108 or other gateways/routers, and run it as software instead, thereby facilitating automated network management and making it easier to integrate and administer business applications, including virtualized applications and cloud-based services.

Referring now to FIG. 5, at reference numeral “122”, the UE 27 may initiate a PDN session and may send a session request with appropriate APN ID and Subscriber ID (for example the IMSI assigned to the UE). The request may propagate through the carrier network 87 and may eventually be received at the EPG 108. In FIG. 5, network entities such as the BNG 38 in FIG. 4 and a Broadband Policy Control Framework (BPCF) (not shown in FIG. 4) that may support clients having non-3GPP access (e.g., WiLAN or Wi-Fi clients) and provide an interface between these clients and the 3GPP CN 90 at different stages of the PDN session are indicated through parenthesis like “(BNG)” (in the box 108 showing EPG) and “(BPCF)” (in the box 44 showing PCRF) for reference. Upon receiving the user request for a PDN session, for example through the BNG 38 in one embodiment, the EPG 108 may notify the PCRF 44 (or the BPCF for broadband clients, as the case may be) at message flow 123 that a session request is received from a new UE (here, the UE 27), the gateway (GW) from which the UE's request is received, the location of the UE 27, and the IP address (“IP@” in FIG. 5) from which the request is received. At message flow 124, the PCRF 44 (or the BPCF, as the case may be) may notify the SDN controller 120 of this session request from the new UE 27 and network operator's service policy such as guaranteed QoS, allocable bandwidth, the maximum threshold for latency delay, and so on applicable to this UE's subscriber. In one embodiment, through its VM Mobility function 110, the SDN controller 120 may select an existing VM service instance or request the VM Management function 114 to create a new VM service instance for the UE's PDN session, as indicated at message flow 125. If necessary, the SDN controller 120 (through the VM mobility function 110) may also request the VM management function 114 for associated VM infrastructure (also referred to as “VM infra” in FIG. 5) resources such as, for example, computing resources, storage resources, and networking resources. In one embodiment, the VM management function 114 may allocate such resources to the UE 27 based on many factors such as, for example, the availability of the corresponding shared hardware. In the embodiment of FIG. 5, the VM management function 114 creates a subscriber-specific, new VM instance, for example the VM instance 118, at the VM 58 in the group of VMs 54 in the DC 100 in accordance with the virtual software image and network configuration requested by the SDN controller 120 (using, for example, its VM mobility function 110), as indicated at message flow 127. The “image” may specify a software to be loaded specific to the virtual application associated with the VM instance 118. The networking configuration may specify the “networking” required to setup a specific VM (here, the VM 58).

In the embodiment of FIG. 5, at message flow 128, the EPG 108—in conjunction with the VM mobility function 110 at the SDN CTL 120—may configure a GRE tunnel to the VMs 58-60 in the DC 100 either in parallel to the events at sequences 125 and 127, or after the conclusion of the events at sequences 125 and 127. At the message flow 128, the EPG 108 may also configure VM (or VM infra) tunnel endpoints for the GRE tunnel by including GRE protocol keys or static Layer-2 Tunneling Protocol version 3 (L2TPv3) IP Security (IPSec) keys, as well as by including GRE protocol ID or static L2TPv3 ID as part of the configuration. As is known, the L2TP is an OSI Layer-2 (L2, the data-link layer) tunneling protocol used to support Virtual Private Networks (VPNs) or as part of the delivery of services by Internet Service Providers (ISPs) including, for example, the DC-based content providers. IPSec is often used with L2TP to secure L2TP packets by providing confidentiality, authentication, and integrity. The combination of these two protocols is generally referred to as “L2TP/IPSec.” As indicated at the optional message flow 129, additional in-band tunnel set-up mechanisms may apply. In other words, instead of or in addition to the GRE tunnel, which is used as an example here, the EPG 108 may setup additional or alternative tunnels to the VMs 58-60 such as, for example, the GTP tunnel 112 (shown in FIG. 4) with a corresponding Tunnel Endpoint ID (TEID) or an L2TPv3 tunnel. As a result, at least one new data plane tunnel may be now established between the EPG 108 and the DC-based VMs 58-60 as indicated at reference numeral “130.” As mentioned earlier, in one embodiment, such tunnel may allow the CN-based EPG 108 to control mobility of a subscriber-specific instance from one VM to another.

After the tunnel is established at message flow 130, the SDN controller 120 may instruct the EPG 108 to map subscriber access session information to the respective transport tunnel (whether a GRE tunnel, a GTP tunnel, etc.) to the VMs 58-60. Such access session information may include, for example, PDN connection information such as APN ID, and information about a Point-to-Point Protocol (PPP) session (if applicable). A PPP session may be used, for example, during dial-up cable connections to the Internet or the CP's resources at the DC 100 via a telephone modem, or during other types of broadband access including broadband access via a cellular network. The access session information may also include information about a Dynamic Host Configuration Protocol (DHCP) subscriber, which may be the UE 27, for example, receiving IP addresses that are dynamically allocated using the DHCP protocol, and the like. In response, as indicated at block 132, the EPG 108 may create a binding between the VM instance number for the subscriber-specific VM instance 118, which may have been supplied to the EPG 108 by the VM management function 114 through the tunnel created at message flow 130, and each of a number of other parameters such as, for example, the UE's IMSI (for the UE 27), APN ID (received at message flow 122), tunnel ID for the tunnel created at message flow 130 (which may be a GTP tunnel ID or TEID in case of the GTP tunnel 112 in FIG. 4), and so on. As a result of such binding, the EPG 108 may be now able to communicate directly to the VMs 58-60 to receive from the VM management function relevant Key Parameter Index (KPI), such as hardware failure, overload indication, memory shortage, lack of compute-processing capacity, etc., to move the UE's session to a different VM instance (as discussed below with reference to the exemplary embodiments in FIGS. 6 and 7), etc. The EPG 108 may then set up a PDN session with the UE 27 (as indicated at message flow 133), thereby allowing the subscriber of the UE to have access to the corresponding virtualized application or cloud service.

FIGS. 6A and 6B (collectively “FIG. 6”) illustrate an exemplary sequence diagram (or message flow) 135 related to a bandwidth-based VM mobility trigger according to one embodiment of the present disclosure. At reference numeral “137”, the subscriber UE 27 initiates a video content session (e.g., via YouTube®, Netflix®, etc.) such as, for example, a movie download or delivery of streaming audio-visual content. As indicated at block 138, the EPG 108 may be informed of this event (i.e., the UE's initiation of a virtualized application session) either via a Diameter protocol-based Gx message, which is used to exchange policy decisions-related information) from the PCRF 44 or from its own DPI application/function (discussed earlier), or from a direct REST/Web Services notification from the relevant Content Provider (CP), or through other means. Consequently, the EPG 108 may retrieve UE's 27 policy for this video application from the PCRF 44 as indicated at reference numeral “140”. This policy may be specific to the UE's subscriber and may indicate, for example, what bandwidth and guaranteed QoS the subscriber is entitled to for this video content session application. At message flow 142, the EPG 108 may retrieve the current loading condition of the relevant VMs 58-60. These VMs may be those VMs that support the applications for a given CP. In one embodiment, these VMs may be owned, operated, or managed by the CP, or a third party, including the operator of the network 87, through an SLA with the CP. At block 144, the EPG 108 may decide to move the UE-specific video content session to a different VM instance based on a number of factors such as, for example, the network operator's policy related to charging, QoS, bandwidth availability, and so on applicable to the UE/subscriber 27, the type of the current video application (e.g., bandwidth-intensive or not), current location of the UE (e.g., geographically near a VM that is different from the VM 58 which is currently hosting the UE's subscriber-specific VM instance 145), loading condition of relevant VMs, and the like. The EPG 108 may determine that the video application associated with the UE's VM instance requires high bandwidth, which may not be satisfied by the current VM 58. As a result, at message flow 146, the EPG 108 may instruct the VM management function 114 to move, scale up, or replicate the UE's VM instance to another location/VM that can satisfy the high bandwidth requirement. In response, as indicated at message flow 147, the VM management function 114 may move (as symbolically illustrated by arrow 148) the UE's entire session to another VM instance (here, a VM instance 149 on the different VM 60). This new VM 60 may be selected by the VM management function 114 because it may be better equipped to handle the UE application's high bandwidth requirement. Thereafter, at message flow 150, the VM Management function 114 may return a new VM instance number (for the VM instance 149 created on the new VM 60 when the subscriber-specific VM session was moved to this new VM 60) to the EPG 108. The VM management function 114 may also update its binding between the GTP tunnel ID (of the GTP tunnel 112 between the EPG 108 and the VM Management function 114 as shown in FIG. 4) and this new VM instance number. In case of any other type of tunnel or interface (for example L2TPv3, GRE, VXLAN, and the like) with a core network instead of, or in addition to, the GTP interface discussed here, the VM Management function 114 may update its binding between that tunnel/interface ID and the new VM instance number, as indicated at message flow 150. As a result, the EPG 108 also updates its bindings between the new VM instance number and UE's IMSI, APN ID, GTP tunnel ID, etc., as indicated at block 151 in FIG. 6B (which is a continuation of FIG. 6A). The VM mobility related messaging flows in FIG. 6 may be transparent to the UE 27. Once the UE's VM instance is moved from the VM 58 to the VM 60, the UE may continue receiving high quality video at the requisite bandwidth (as noted at block 152).

FIGS. 7A and 7B (collectively “FIG. 7”) depict an exemplary message flow or sequence diagram 155 related to latency delay- and UE location-based VM mobility trigger according to one embodiment of the present disclosure. Initially, at message flow 157, the UE 27 may initiate a delay-sensitive session such as a financial transaction session by a broker, a medical information-sharing session by an emergency responder, and the like that requires low latency delay during execution. As indicated at block 158, the EPG 108 may be informed of the UE's initiation of a virtualized application or cloud-based service session either via a Diameter protocol-based Gx message from the PCRF 44 or from its own DPI application/function (discussed earlier) or from a direct REST/Web Services notification from the relevant CP (for example, a brokerage house, an emergency service network, and the like) or through other means. Consequently, the EPG 108 may retrieve UE's 27 policy for this delay-sensitive application from the PCRF 44 as indicated at reference numeral “160”. This policy may be specific to the UE's subscriber and may indicate, for example, what delay threshold and guaranteed QoS the subscriber is entitled to for this delay-sensitive application. At message flow 162, the EPG 108 may retrieve the current loading condition of the relevant VMs (e.g., the VMs 58-60 in the group of VMs 54). These VMs may be those VMs that support the applications for a given CP. As mentioned earlier with reference to FIG. 6, in one embodiment, these VMs may be owned, operated, or managed by the CP, or a third party, including the operator of the network 87, through an SLA with the CP. At block 164, the EPG 108 may decide to keep the UE-specific application session to the current VM 58 (i.e., the subscriber-specific VM instance 165 at the VM 58) based on a number of factors such as, for example, the network operator's policy related to charging, QoS, latency requirements, and the like applicable to the UE/subscriber 27, the type of the current application (e.g., a low latency application or not), current location of the UE (e.g., geographically near the VM 58 that is currently hosting the UE's subscriber-specific VM instance 165), loading condition of relevant VMs, and so on. The EPG 108 may determine that the current application associated with the UE's VM instance 165 requires low latency delay, which may be satisfied by the current VM 58 and, hence, there may not be any need to move the UE's VM instance 165. The messaging flows in FIG. 7A may be transparent to the UE 27. Once the EPG 108 determines to maintain the UE's current session at the current VM 58, the UE 27 may be allowed to resume its high-speed (i.e., low latency) application session (as noted at block 166).

Referring now to FIG. 7B (which is a continuation of FIG. 7A), it is observed at block 167 that the UE 27 may start, for example, a video session and move far away from its originating location such as, for example, the location associated with UE's session initiation at message flow 157. Thus, the UE 27 may have physically moved far away from the location where VM 58 is implemented that hosts its VM instance 165. The EPG 108 may receive a trigger from its own application or from another network node in the EPC 90 informing the EPG 108 of the UE's geographical movement. As a result, the EPG 108 may decide to move the UE's VM instance 165 to a Data Center (DC) that is geographically closer to the UE's current (physical) location as noted at block 168 so as to better fulfill the low latency delay requirement of the subscriber's delay-sensitive session. Consequently, as indicated at message flow 170, the EPG 108 may instruct the VM Management function 114 to move the UE's current VM instance 165 to another location that can satisfy the low latency requirement of UE's delay-sensitive application. In response, as indicated at message flow 172, the VM management function 114 may move the UE's session to another VM 66 by creating a new subscriber-specific VM instance 174 at the VM 66, as symbolically shown by arrow 175. The new VM 66 may be at a different physical location (“Location B” in FIG. 7 as opposed to “Location A” of the original VM 58) which may be geographically closer to the UE's current physical location. In FIG. 7 (i.e., FIGS. 7A and 7B), it is assumed that the DC 100 hosts its VMs in a distributed manner—i.e., the group of VMs 54 may be at a physical location (“Location A”) that is different from the physical location (“Location B”) where the other group of VMs 56 is hosted. However, in another embodiment, the VMs at Location B may not belong to the DC 100, but may be associated with a completely different data center (e.g., the DC 101 in FIG. 2) that hosts VMs managed by the VM Management function 114. This other data center may be at a different geographical location, but may still be owned, operated, or managed by an entity or CP associated with the DC 100. On the other hand, the new data center may be owned, operated, or managed by an entity that is different from the entity associated with the DC 100. In any event, the new data center at Location B may still host VMs that support the applications that were supported by the VMs at Location A.

Thereafter, at message flow 177, the VM Management function 114 may return a new VM instance number (for the VM instance 174 created on the new VM 66 when the subscriber-specific VM session was moved to this new VM 66) to the EPG 108. The VM management function 114 may also update its binding between the GTP tunnel ID (of the GTP tunnel 112 between the EPG 108 and the VM Management function 114 as shown in FIG. 4) and this new VM instance number. In case of any other type of tunnel or interface (e.g., L2TPv3, GRE, VXLAN, etc.) with a core network instead of, or in addition to, the GTP interface discussed here, the VM Management function 114 may also update its binding between that tunnel/interface ID and the new VM instance number. As a result, the EPG 108 also updates its bindings between the new VM instance number and UE's IMSI, APN ID, GTP tunnel ID, etc., as indicated at block 178 in FIG. 7B. The VM mobility related messaging flows in FIG. 7 may be transparent to the UE 27. Once the UE's VM instance is moved from the VM 58 to the VM 66, the UE may continue receiving high quality video at the requisite low latency delay (as noted at block 180).

It is observed here that the VM mobility in FIG. 6 may be considered an example of an intra-DC (i.e., within the same DC 100) mobility of VMs, whereas the VM mobility in FIG. 7 may be considered an example of an inter-DC (i.e., between two difference DCs) mobility of VMs when the VMs at Location-B belong to a data center that is different from the DC 100 to which the VMs at Location-A belong.

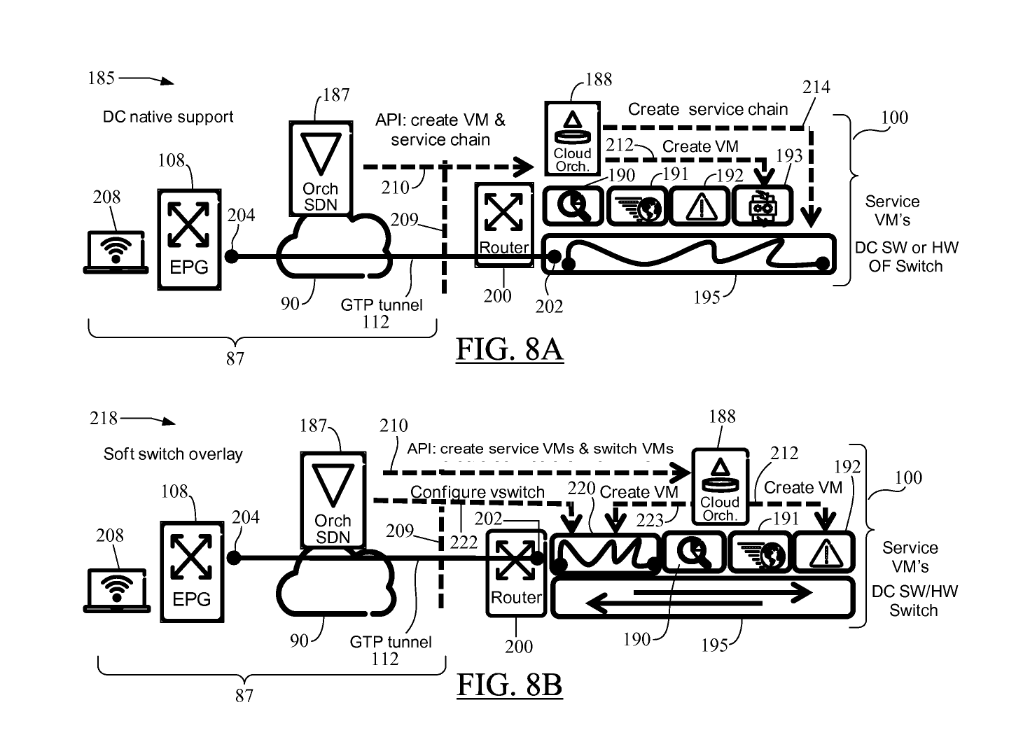

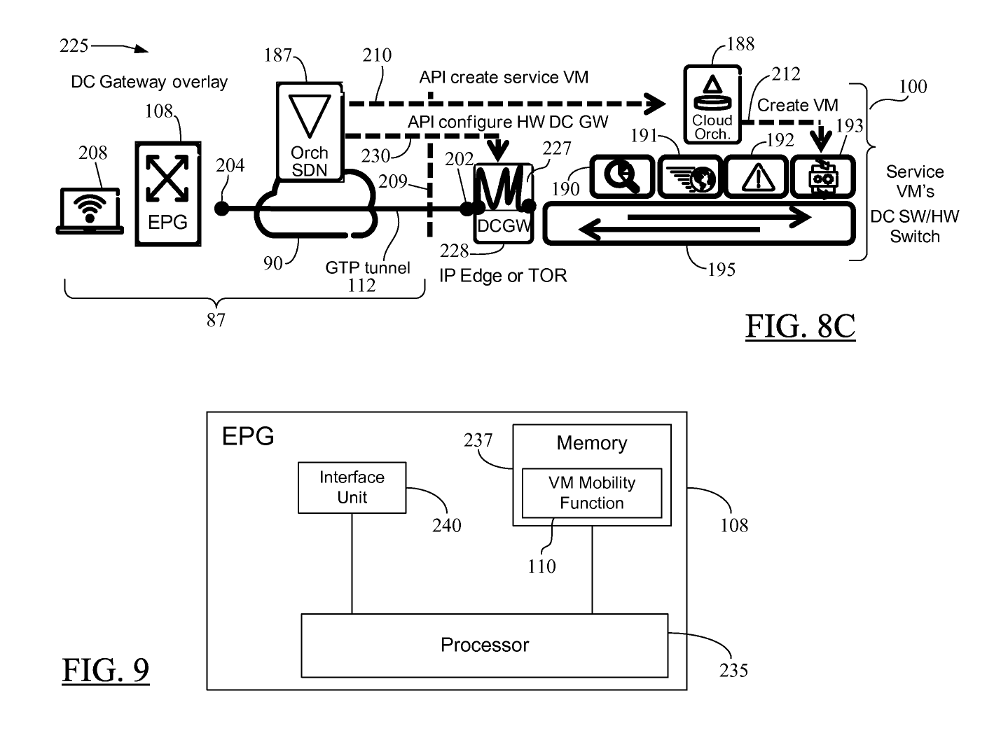

FIGS. 8A through 8C (collectively “FIG. 8”) illustrate exemplary configurations 185, 218, and 225, respectively, regarding how to provide appropriate network connectivity between an operator's core network such as EPC 90 in FIG. 4 and a data center such as DC 100 in FIG. 4 to support the VM mobility solution according to particular embodiments of the present disclosure. The embodiments in FIGS. 8A-8C are more focused on functional aspects of how such network connectivity may be provided in practice to accomplish intra-DC and inter-DC mobility of a VM instance. Hence, the configurations in FIGS. 8A-8C may not exactly correspond with the configuration in FIG. 4. For example, the VM Management function 114 is not shown in FIGS. 8A-8C, however, as discussed below, its functionality may be accomplished through a Cloud Orchestrator 188. Furthermore, even though the GTP tunnel 112 is shown with different tunnel endpoints in FIGS. 8A-8C, that does not mean that FIGS. 8A-8C contradict FIG. 4 because of absence of a depiction of a GTP tunnel connected to the VMs 190-193 in FIGS. 8A-8C. The functional layouts in FIGS. 8A-8C implement the configuration depicted in FIG. 4.

In FIGS. 8A-8C, a Cloud Orchestrator functionality, or environment, is shown to have been implemented in a distributed manner—in the carrier network 87, for example as part of an SDN controller at block 187, wherein the SDN controller may be part of the CN 90 or, more specifically, a part of the EPG 108, and as a cloud-based controller 188 for the DC 100. Thus, in one embodiment, the functionality of the Cloud Orchestrator 187 may be performed by the EPG 108. Also, in one embodiment, the controller 188 may be implemented as part of the DC 100. In the embodiments of FIGS. 8A-8C, both of these implementations 187-188 co-operate with each other and jointly provide the Cloud Orchestrator functionality. Hence, for ease of discussion, both of these implementations 187-188 may be singularly (and jointly) referred to as a “Cloud orchestration environment” or “Cloud Orchestrator.” A Cloud Orchestrator may provide an automated support for virtualization management such as, for example, management of (i) instantiation or creation of a VM, (ii) decommissioning of a VM, (iii) Fault Configuration Accounting Performance Security (FCAPS) (e.g., how to account or charge for subscriber usage of VM services, how to provide security that two virtualized applications do not “see” the data of each other, how to accomplish fault tolerance), etc. Hence, in one embodiment, each of the Cloud Orchestrators 187-188 in FIGS. 8A-8C may include features of the VM Management function 114. In other words, in particular embodiments, the VM management functionality also may be implemented in a distributed manner through the Cloud orchestration environment.

It is noted that a VM may have specific requirements for network connectivity or performance. For example, a VM may require a specific Network Interface Controller (NIC) chipset, interface bandwidth (BW), specific instruction set—such as an instruction set for an Intel® chipset or an Advanced Micro Devices, Inc. (AMD™) chipset, etc. Hence, the Cloud Orchestrator 188 may have to find the right target server or VM based on the requirement of mobility of a VM (or VM instance). Therefore, in some embodiments, the Cloud Orchestrator 188 may need appropriate network connectivity information, which may be obtained, for example, from a DC switch 195, which may be configured to receive such connectivity information through one of the routing information delivery options shown in FIGS. 8A-8C and discussed below.

In FIGS. 8A-8C, some exemplary “service” VMs 190-193 (which may be considered as representatives of the VMs in the groups of VMs 54-56 in FIG. 4) in the DC 100 are shown having respective “services” or applications hosted thereon. These services or applications are illustrated using different symbolic representations, for example an online search service at VM 190, a World Wide Web application at VM 191, a security/firewall service at VM 192, and an online gaming application at VM 193. A DC switch 195 for the DC 100 is also shown in FIGS. 8A-8C. In one embodiment, the switch 195 may be shared by the VMs 190-193, or each VM 190-193 may implement a corresponding portion of the switch 195, for example when the switch 195 is a software switch. In one embodiment, the switch 195 may include multiple switches; however, for ease of discussion, the singular term “switch” is used herein. This switch 195 may be a software (SW) or hardware (HW) switch operating under the OpenFlow (OF) protocol mentioned earlier. In networking, a “switch” is a device that channels incoming data from any of multiple input ports (not shown) to the specific output port that will take the data towards its intended destination. In a packet-switched wide-area network, such as the Internet, the destination address may require a look-up in a routing table (which may be maintained at a router such as, for example, the router 200 associated with the DC 100 in FIGS. 8A-8B or may be available at the EPG 108). On the other hand, some new switches (also called “IP switches”) may themselves be equipped to perform the routing (L3) functions. In any event, being a third party CP-based entity, the switch 195 in the DC 100 may need routing information such as a routing table to enable the switch 195 or, in some embodiments, the Cloud Orchestrator 188 to appropriately route the outgoing packets or VMs/VM instances to their correct destinations, either via the router 200 in the embodiments of FIGS. 8A-8B or via a Data Center Gateway (DCGW) 228 in the embodiment of FIG. 8C. Therefore, the exemplary configurations in FIGS. 8A-8C may be used to convey such routing information to the DC switch 195 to populate the DC switch with appropriate routing information to manage routing of data packets as well as mobility of VMs/VM instances.

In the embodiment of FIG. 8A, the routing information is conveyed from the EPG 108 to the switch 195 directly via the GTP or GRE tunnel 112 because the switch 195 may be an IP switch capable of performing routing itself or may be part of a VM that has a built-in mechanism for appropriate network connectivity (e.g., routing, load-balancing, tunnel setup, etc.). Such direct connection is illustrated by one of the tunnel endpoints 202 “connected” to the switch 195 and the other endpoint 204 “connected” to the EPG 108. In other words, the DC 100 may have switches that are capable of such native support for routing and, hence, the GTP tunnel 112 may provide a direct link between the DC switch(es) 195 and the EPG 108. As a result, routing information such as a routing table for a data packet, or for the mobility of a VM or VM instance associated with a PDN session of the subscriber device 208 (which may represent any of the UEs 24-28 and 92-93 discussed earlier) may be directly delivered to the DC switch 195, which can then instruct the router 200 for appropriate routing or inform the cloud orchestrator 188 for appropriate routing to support VM mobility requirements.

In FIG. 8A, the vertical dotted line 209 may symbolically represent a “boundary” or separation between the operator's carrier network 87 and the DC 100, and associated entities such as the router 200 and DC-based cloud orchestrator 188. The Cloud Orchestrator 187 may provide an Application Programming Interface (API) (symbolically shown by dotted arrow “210”) to the DC-associated Cloud Orchestrator 188 to enable the Cloud Orchestrator 188 to create VMs (as symbolically indicated by dotted arrow “212”) as well as “service chains” (as symbolically indicated by dotted arrow “214”). The EPG 108 may have certain requirements for different virtualized applications. For example, the EPG 108 may identify which subscribers should have their data traffic go through a firewall application in the DC 100 and which subscribers should not. The “service chain” in the API may identify a subscriber-specific set or “chain” of services such as a firewall application, the earlier-discussed Deep Packet Inspection (DPI) function, and so on that are allowed for a subscriber's packet. Thus, a subscriber-specific “service chain” may be created in the DC switch 195 to configure the switch 195 for appropriate treatment of a subscriber's packet.

Thus, in the configuration 185 in FIG. 8A, VMs or the switch 195 in the DC may provide a built-in mechanism for appropriate network connectivity and, hence, the routing information may be directly delivered to the switch 195 via the tunnel 112. In contrast, the configuration 218 in FIG. 8B may require creation of a software overlay (symbolically represented at reference numeral “220”) that builds the required connectivity environment on top of any DC solution. In other words, only a minimum level of support from the DC 100 (including the DC switch 195) is assumed in the configuration 218 in FIG. 8B. Hence, additional routing information to the switch 195 is supplied through a software switch overlay 220 that may be configured as a virtual switch (or “vswitch”) by the Cloud Orchestrator 187 (as indicated at dotted arrow 222). In one embodiment, the configuration of the vswitch may include the service chain creation aspect, which may be similar to that shown at reference numeral “214” in FIG. 8A, except that the service chain may be created by the Cloud Orchestrator 187 instead of the DC-associated Cloud Orchestrator 188. The vswitch 220 may be in communication with the DC switch 195 and the router 200. In the embodiment of FIG. 8B, the second endpoint 202 of the GTP tunnel 112 may now “connect” to the router 200 (instead of the DC switch 195 directly as in the embodiment of FIG. 8A), which may receive the routing table and any other related routing information from the EPG 108 via the tunnel 112. This routing information may be then supplied from the router 200 to the software overlay 220, which may, in turn, supply the routing information to the DC switch 195 for appropriate routing. In one embodiment, the software overlay 220 may support creation of “switch” VMs (not shown) for routing. The aspect of creation of “switch” VMs at the software overlay 220 may be conveyed through the API at reference numeral “210” as shown in FIG. 8B. In one embodiment, the API may enable the Cloud Orchestrator 188 to create service VMs 190-193 (as symbolically indicated by dotted arrow “212”) and switch VMs (as symbolically indicated by dotted arrow “223”). It is noted here that entities or actions having the same reference numerals in the configurations in FIGS. 8A and 8B are not discussed again with reference to discussion of FIG. 8B. It is observed that, for simplicity of the drawing, the VM 193 is not shown in FIG. 8B.

In contrast to the configuration 218 in FIG. 8B, where routing information is delivered to the DC switch 195 via a software switch overlay 220, the configuration 225 in FIG. 8C may require creation of a hardware (HW) overlay, which is symbolically represented by reference numeral “227” and shown implemented as part of the hardware of a Data Center (DC) Gateway (GW) 228, which may be in communication with the DC switch 195. The hardware switch overlay 227 may provide the required connectivity environment on top of the DC switch 195. In other words, like the configuration 218 in FIG. 8B, only a minimum level of support from the DC 100, including the DC switch 195, is assumed in the configuration 225 in FIG. 8C as well. Hence, additional routing information to the switch 195 is supplied through the hardware switch overlay 227 that may be configured through an API (from the Cloud Orchestrator 187) as part of configuring the hardware of the DC GW 228 (as indicated at dotted arrow 230). In one embodiment, the configuration of this GW-based HW switching overlay 227 may include the service chain creation aspect, which may be similar to that shown at reference numeral “214” in FIG. 8A, except that the service chain may be created by the Cloud Orchestrator 187 instead of the DC-associated Cloud Orchestrator 188. In one embodiment, the HW GW 228 associated with the DC 100 may be configured to implement The Onion Router (TOR) software for enabling online anonymity. In another embodiment, the DC GW 228 may implement the functionality of an IP edge router to transfer data between a local area network (such as, for example, a CP-specific network (not shown) that includes the DC 100) and a wide area network (e.g., the Internet or the cellular operator's network 87). In this embodiment, the GW 228 may sit at the periphery, or edge, of a network.

In the embodiment of FIG. 8C, the second endpoint 202 of the GTP tunnel 112 may now “connect” to the GW 228, which may receive the routing table (and any other related routing information) from the EPG 108 via the tunnel 112. This routing information may be then supplied to the DC switch 195 through the hardware switch overlay 227. It is noted here that entities or actions having the same reference numerals in the configurations in FIGS. 8A and 8C are not discussed again with reference to discussion of FIG. 8C.

It is noted here that, in one embodiment, when the mobility control function such as the VM Mobility function 110 is external to the GW 228 (for example at the SDN controller as shown in FIG. 5) or at another service automation function, which may be part of the VM Orchestrator 187 as shown in FIG. 8C, and when GTP is used as tunnel technology, then an option is to overload existing tunnel setup mechanisms, for example the S5, S8, or S2a interfaces in LTE, to allow an existing GW such as the GW 228 to connect to the VM infrastructure at the DC 100.

FIG. 9 depicts a block diagram of an exemplary network node such as the EPG 108 in a core network such as the EPC 90 in FIG. 4 through which the VM mobility solution according to particular embodiments of the present disclosure may be implemented. The network node 108 may be configured to anchor therein a VM session associated with a subscriber-specific VM instance of a mobile subscriber in the operator's carrier network 87. The network node 108 may also control the mobility of that VM instance from one VM to another. Thus, EPG-related functionalities discussed earlier with reference to FIGS. 3-8 may be performed by the network node 108. In one embodiment, the network node 108 may implement a VM Mobility function such as the VM Mobility function 110 in FIG. 4, which may configure the network node 108 to perform these EPG-related functions.

The network node 108 may include a processor 235, a memory 237 coupled to the processor 235, and an interface unit 240 also coupled to the processor 235. In one embodiment, the program code for the VM Mobility function 110 may be stored in the memory 237. Upon execution of that program code by the processor 235, the processor 235 may configure the network node 108 to perform various EPG-related functions discussed earlier with reference to FIGS. 3-8. The memory 237 may also store data and other related communications such as routing information, subscriber-specific policy information received from the PCRF 44, loading information for different VMs in the DC 100, information related to a subscriber's PDN session or usage of a particular virtual application/cloud based service, as well as outputs from the processing performed by the processor 235. These data or communications may be used by the processor 235 to perform various EPG-based tasks such as establishment of the GTP tunnel 112, transmission of routing information to the DC switch 195, instructing the VM Management function 114 to move a VM instance from one VM to another, and so on, as discussed earlier with reference to FIGS. 3-8. The interface unit 240 may provide a bi-directional interface to enable the EPG 108 to communicate with other network nodes/entities or functions in the core network 90 and also to communicate with other entities, functions, or elements such as the VMs in the DC 100, the VM Management function 114, and the like beyond the CN 90.

In one embodiment, the processor 235 may be configured in hardware or hardware and software (such as the VM Mobility function 110) to implement EPG-specific aspects of the VM mobility solution as per teachings of particular embodiments of the present disclosure. Hence, some or all of the functionalities described above (for example establishment of a GTP tunnel, anchoring of a subscriber's VM session, and control of the mobility of a subscriber-specific VM instance) as being provided by the network node 108 or another network node in the CN 90 having similar functionality, may be provided by the processor 235 executing instructions stored on a computer-readable data storage medium, such as the memory 137 in FIG. 9. In one embodiment, some or all aspects of the VM mobility solution provided herein may be implemented in a computer program, software, or firmware incorporated in a non-transitory computer-readable storage medium such as the memory 237 in FIG. 9 for execution by a general purpose computer or a processor such as the processor 235 in FIG. 9. Examples of computer-readable storage media include a Read Only Memory (ROM), a Random Access Memory (RAM), a digital register, a cache memory, semiconductor memory devices, magnetic media such as internal hard disks, magnetic tapes and removable disks, magneto-optical media, and optical media such as CD-ROM disks and Digital Versatile Disks (DVDs). In certain embodiments, the memory 237 may employ distributed data storage with/without redundancy.

In one embodiment, when the existing hardware architecture of the network node 108 cannot be modified, the functionality desired of the node 108 may be obtained through suitable programming of the processor 235 using the VM Mobility function 110. The execution of the program code by the processor 235 may cause the processor to perform as needed to support the VM mobility solution as per the teachings of the present disclosure. Thus, although the EPG 108 may be referred to as “performing,” “accomplishing,” or “carrying out” (or similar such other terms) a function or a process or a message flow step, such performance may be technically accomplished in hardware and/or software as desired. The network operator or a third party such as the manufacturer or supplier of the CN 90 or the EPG 108 may suitably configure the network node 108 through hardware and/or software based configuration of the processor 235 to operate as per the particular requirements of the present disclosure discussed above.

The processor 235 may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. The processor 235 may employ distributed processing in certain embodiments.

Like the EPG 108 in FIG. 9, other network nodes in the CN 90 such as the PCRF 44, the MME 48, and so on may also be implemented by at least one processor, a memory coupled the at least one processor, and computer-readable instructions stored in the memory. The computer-readable instructions, when executed by the at least one processor, may configure the processor to implement various relevant aspects described hereinbefore. Alternative embodiments of the network node 108 or any of the other nodes in the CN 90 may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features and elements.

The foregoing describes a system and method for controlling mobility of a subscriber-specific VM instance associated with a subscriber-specific VM session from one VM to another VM using a network node in a packet-switched CN such as an EPC in a mobile communication network. Given the EPC's knowledge of subscriber's preferences and roaming, it is beneficial to have the EPC, or more specifically a network node such as an EPG in the EPC, control the VM mobility for each subscriber to let the subscribers have the best user experience that the network can provide (in the context of cloud-based services or virtualized applications) and also enable the operators to deploy virtualized applications such as telecom apps, IT apps, web-related apps, and the like in an optimized way for their mobile subscribers. The EPG may move a subscriber's VM instance between VMs (intra-DC or inter-DC) based on the cellular network operator's policy, network load, subscriber's application requirement, subscriber's current location, subscriber's SLA with the operator, etc. The EPG may use GTP tunnels rooted at the EPG to data center VMs to govern intra-DC and inter-DC mobility of VMs and also to tie in the mobility triggers to service provider's PCRF policies. Each VM session for the mobile subscribers may be anchored in the EPG, which may then assume the control of VM mobility for each subscriber by establishing a new GTP interface with the VMs at a DC. The EPC-based control of VM mobility can provide optimization of cloud services accessed by a subscriber over a mobile connection.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method for managing mobility of a subscriber-specific Virtual Machine (VM) instance from a first VM to a second VM for a mobile subscriber in a mobile communication network, wherein the VM instance is initially created in the first VM that is implemented at a first Data Center (DC) associated with the mobile communication network, and wherein the method comprises performing the following using a network node in a packet-switched Core Network (CN) in the mobile communication network:
anchoring a VM session associated with the VM instance; and
controlling the mobility of the subscriber-specific VM instance from the first VM to the second VM, wherein the second VM is implemented at one of the following:
the first DC, and
a second DC that is different from the first DC.

2. The method of claim 1, wherein the network node is one of the following:
an Evolved Packet Gateway (EPG); and
a Packet Data Serving Node (PDSN).

3. The method of claim 1, wherein the CN is an Evolved Packet Core (EPC).

4. The method of claim 1, further comprising performing the following using the network node:
implementing a VM mobility function in the network node.

5. The method of claim 1, wherein the anchoring of the VM session includes performing the following using the network node:
establishing a tunnel with the first and the second VMs, wherein the tunnel enables the first and the second VMs each to create a corresponding first binding between a tunnel Identifier (ID) for the tunnel and a VM instance number for the VM instance; and
creating a second binding among the tunnel ID, a subscriber ID for the mobile subscriber, and the VM instance number.

6. The method of claim 5, wherein the tunnel is one of the following:
a General Packet Radio Service (GPRS) Tunneling Protocol (GTP) tunnel; and
a Generic Routing Encapsulation (GRE) tunnel.

7. The method of claim 5, wherein the anchoring of the VM session further includes performing the following using the network node:
establishing the tunnel with a VM management function, wherein the tunnel enables the VM management function to create a third binding between the tunnel ID and the VM instance number.

8. The method of claim 7, wherein the controlling of the mobility of the subscriber-specific VM instance includes:
through the VM mobility function, the network node instructing the VM management function to move, scale up, or replicate the subscriber-specific VM instance from the first VM to the second VM.

9. The method of claim 5, wherein the controlling of the mobility of the subscriber-specific VM instance includes performing the following using the network node:
providing routing information associated with the mobility of the subscriber-specific VM instance to a switch in the first DC via the tunnel.

10. The method of claim 9, wherein providing the routing information includes:
providing the routing information using one of the following:
a software switch overlay in communication with the switch in the first DC; and
a hardware switch overlay in communication with the switch in the first DC.

11. The method of claim 1, wherein the controlling of the mobility of the subscriber-specific VM instance includes:
the network node triggering the mobility of the subscriber-specific VM instance from the first VM to the second VM based on at least one of the following:
a change in geographical location of the mobile subscriber;
a requirement in a subscriber-specific Policy and Charging Rules Function (PCRF) policy associated with a mobile application being used by the mobile subscriber, wherein the requirement includes at least one of the following:
a radio bandwidth threshold,
a latency delay threshold;
a first Service Level Agreement (SLA) between the mobile subscriber and an operator of the mobile communication network;
a change in a second SLA between the operator of the mobile communication network and an owner of the first VM;
a change in a loading condition of the first VM;
a change in network topology of the mobile communication network;
a new service subscribed by the mobile subscriber from the operator of the mobile communication network;
a need to control power consumption of at least one of the first VM and the second VM; and
a change in availability of hardware resources for the first VM.

12. A network node in a packet-switched Core Network (CN) in a mobile communication network for managing mobility of a subscriber-specific Virtual Machine (VM) instance from a first VM to a second VM for a mobile subscriber in the mobile communication network, wherein the VM instance is initially created in the first VM that is implemented at a first Data Center (DC) associated with the mobile communication network, and wherein the network node is configured to perform the following:
anchor, in the network node, a VM session associated with the VM instance; and
control the mobility of the subscriber-specific VM instance from the first VM to the second VM, wherein the second VM is implemented at one of the following:
the first DC, and
a second DC that is different from the first DC.

13. The network node of claim 12, wherein the network node is one of the following:
an Evolved Packet Gateway (EPG); and
a Packet Data Serving Node (PDSN).

14. The network node of claim 12, wherein the network node is configured to perform the following to anchor the VM session:
establish a tunnel with the first and the second VMs, wherein the tunnel enables the first and the second VMs each to create a corresponding first binding between a tunnel Identifier (ID) for the tunnel and a VM instance number for the VM instance;
create a second binding among the tunnel ID, a subscriber ID for the mobile subscriber, and the VM instance number; and
further establish the tunnel with a VM management function, wherein the tunnel enables the VM management function to create a third binding between the tunnel ID and the VM instance number.

15. The network node of claim 14, wherein the tunnel is one of the following:
a General Packet Radio Service (GPRS) Tunneling Protocol (GTP) tunnel; and
a Generic Routing Encapsulation (GRE) tunnel.

16. The network node of claim 14, wherein the network node is configured to implement a VM mobility function therein, and wherein the network node is further configured to perform the following to control the mobility of the subscriber-specific VM instance:
through the VM mobility function, instruct the VM management function to move, scale up, or replicate the subscriber-specific VM instance from the first VM to the second VM.

17. The network node of claim 12, wherein the network node is configured to control the mobility of the subscriber-specific VM instance by triggering the mobility of the subscriber-specific VM instance from the first VM to the second VM based on at least one of the following:
a change in geographical location of the mobile subscriber;
a requirement in a subscriber-specific network policy associated with a mobile application being used by the mobile subscriber, wherein the requirement includes at least one of the following:
a radio bandwidth threshold,
a latency delay threshold;
a first Service Level Agreement (SLA) between the mobile subscriber and an operator of the mobile communication network;
a change in a second SLA between the operator of the mobile communication network and an owner of the first VM;
a change in a loading condition of the first VM;
a change in network topology of the mobile communication network;
a new service subscribed by the mobile subscriber from the operator of the mobile communication network;
a need to control power consumption of at least one of the first VM and the second VM; and
a change in availability of hardware resources for the first VM.

18. A system for managing mobility of a subscriber-specific Virtual Machine (VM) instance from a first VM to a second VM for a mobile subscriber in a mobile communication network, the system comprising:
a first Data Center (DC) associated with the mobile communication network and implementing the first VM, wherein the VM instance is initially created at the first VM;
a second DC associated with the mobile communication network, wherein the second DC is in communication with the first DC and is different from the first DC; and
an Evolved Packet Core (EPC) of the mobile communication network coupled to the first DC and the second DC, wherein the EPC is configured to perform the following:
anchor a VM session associated with the VM instance, and
control the mobility of the subscriber-specific VM instance from the first VM to the second VM, wherein the second VM is implemented at one of the following:
the first DC, and
the second DC.

19. The system of claim 18, further comprising:
a VM management function wherein the EPC is configured to perform the following to anchor the VM session:
establish a tunnel with the first and the second VMs, wherein the tunnel enables the first and the second VMs each to create a corresponding first binding between a tunnel Identifier (ID) for the tunnel and a VM instance number for the VM instance;
create a second binding among the tunnel ID, a subscriber ID for the mobile subscriber, and the VM instance number;
further establish the tunnel with the VM management function, wherein the tunnel enables the VM management function to create a third binding between the tunnel ID and the VM instance number.

20. The system of claim 19, wherein the EPC is configured to implement a VM mobility function, and wherein the EPC is configured to perform the following to control the mobility of the subscriber-specific VM instance:
through the VM mobility function, instruct the VM management function to move, scale up, or replicate the subscriber-specific VM instance from the first VM to the second VM.
